(19) United States
(12) Patent Application Publication
(10) Pub. No.: US 2026/0204037 A1
(43) Pub. Date: Jul. 16, 2026

(54) OBJECT RESIZING

(71) Applicant: thinAir Technologies, Inc., Covington, LA (US)

(72) Inventor: Jeremey Charbonnet, Covington, LA (US)

(21) Appl. No.: 19/444,862

(22) Filed: Jan. 9, 2026

Related U.S. Application Data
(60) Provisional application No. 63/745,721, filed on Jan. 15, 2025.

(51) Int. Cl. G06T 19/20; G06F 3/04845

(52) U.S. Cl. CPC G06T 19/20; G06F 3/04845

(57) ABSTRACT

In one implementation, a method of resizing objects is performed by a device including one or more processors and non-transitory memory. The method includes displaying a graphical representation of an object, wherein the object has at least a first child object. The method includes receiving user input to change a size of the object in a dimension of a three-dimensional coordinate system of the object by a percentage. The method includes, in response to receiving the user input, changing the size of the object in the dimension by the percentage and maintaining a size of the first child object in the dimension.

### CROSS-REFERENCES TO RELATED APPLICATIONS

This application claims priority to U.S. Provisional Patent App. No. 63/745,721, filed on Jan. 15, 2025, which is hereby incorporated by reference in its entirety.

### TECHNICAL FIELD

The present disclosure generally relates to systems, methods, and devices of resizing an object in a scene compositing user interface.

### BACKGROUND

In various implementations, a scene composing user interface facilitates composition of a scene including one or more objects. Further, the scene composing user interface facilitates changing a location, rotation, and/or size of the objects of the scene.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1I illustrate an electronic device displaying a scene composing user interface with a first scene opened during a plurality of time periods.

FIGS. 2A-2I illustrate the electronic device of FIGS. 1A-1I displaying the scene composing user interface with a second scene opened during a plurality of time periods.

FIGS. 3A-3F illustrate the electronic device of FIGS. 1A-1I displaying the scene composing user interface with a third scene opened during a plurality of time periods.

FIGS. 4A-4G illustrate the electronic device of FIGS. 1A-1I displaying the scene composing user interface with a fourth scene opened during a plurality of time periods.

FIG. 5 is a flowchart representation of a method of resizing objects in accordance with some implementations.

FIG. 6 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for resizing an object. In various implementations, the method is performed by a device having one or more processors and non-transitory memory. The method includes displaying a graphical representation of an object, wherein the object has at least a first child object. The method includes receiving user input to change a size of the object in a dimension of a three-dimensional coordinate system of the object by a percentage. The method includes, in response to receiving the user input, changing the size of the object in the dimension by the percentage and maintaining a size of the first child object in the dimension.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

In various scene composing applications, an object may be associated with a child object. Typically, when the object is resized, the child object is proportionally resized. Other child objects of the object are similarly resized. However, in various implementations, it may be desirable that the child objects are not resized or are resized not in proportion to the object. Accordingly, in various implementations, the object is associated with a construction plan which indicates, for various dimensions of the object, the corresponding dimensions of each child object.

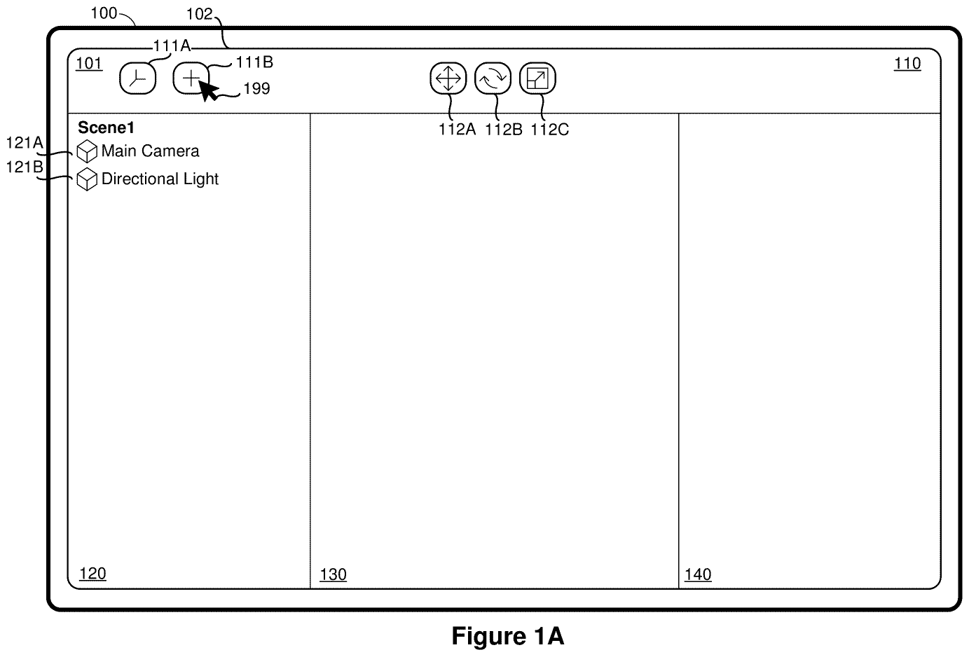

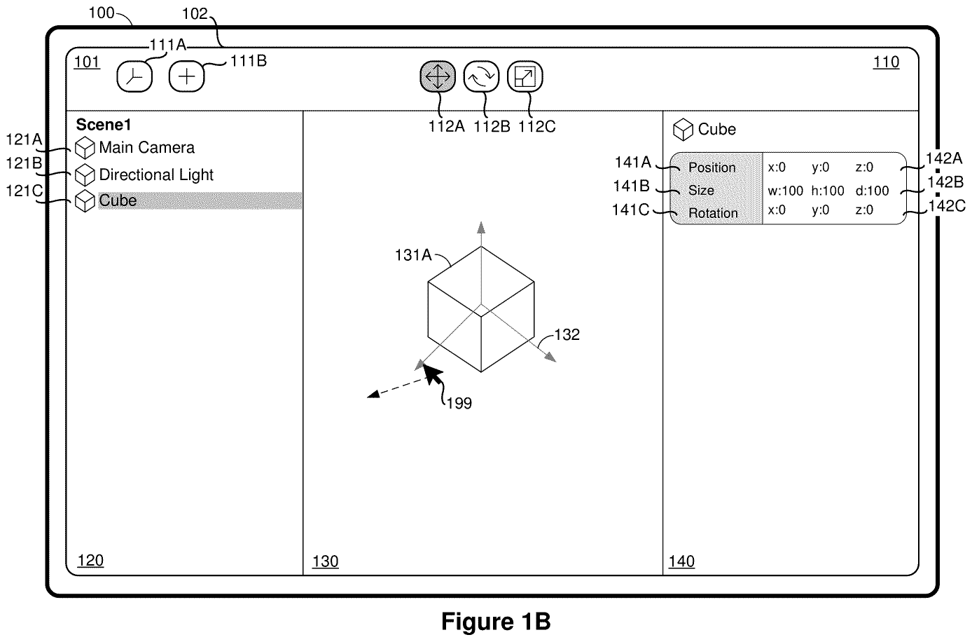

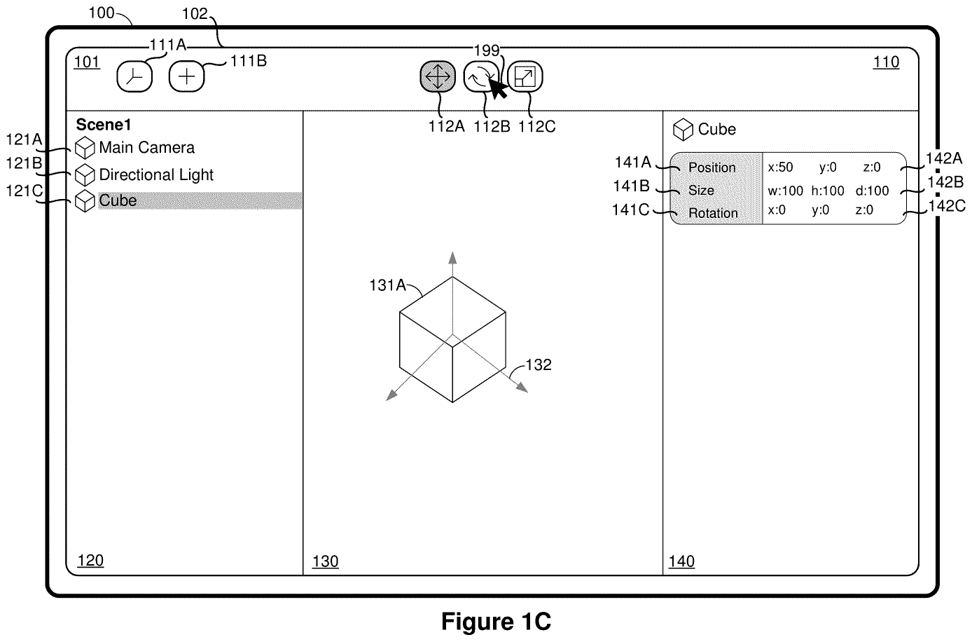

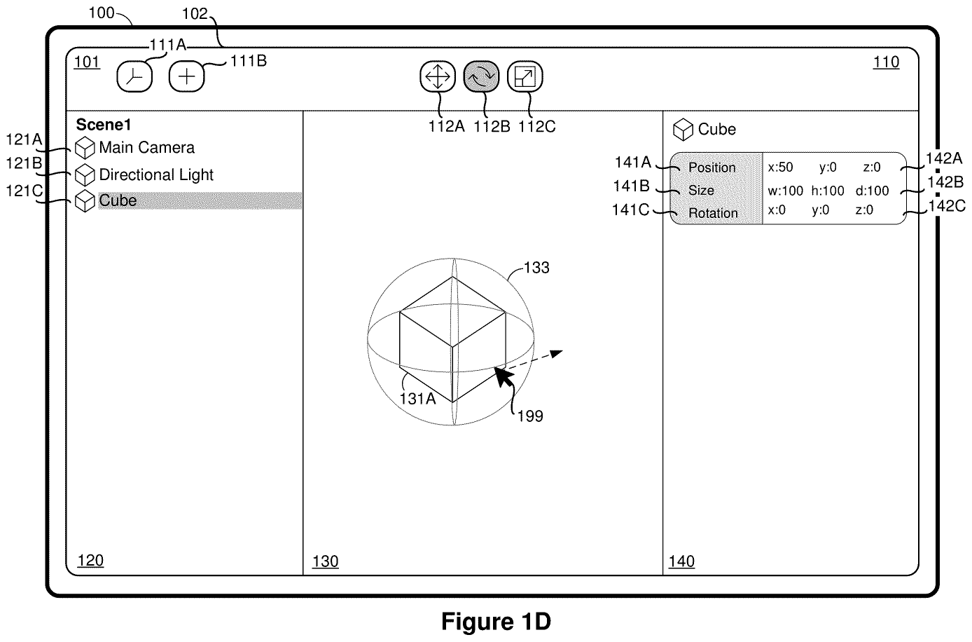

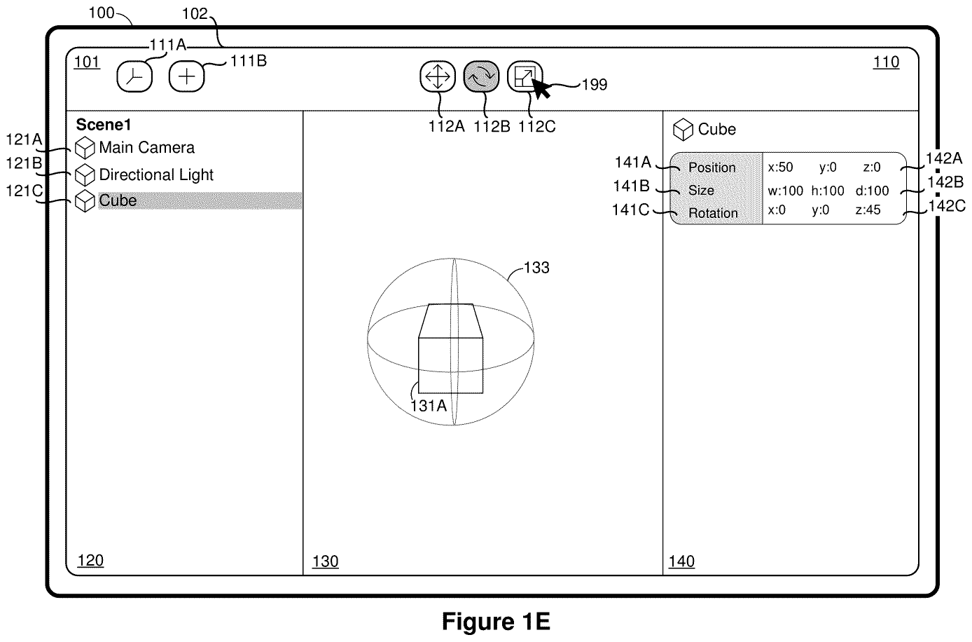

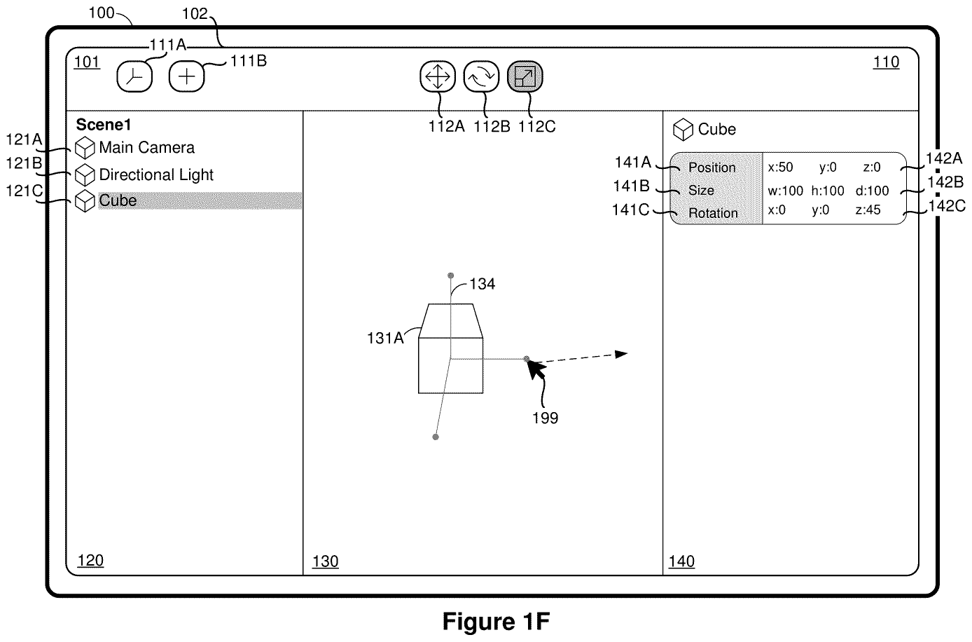

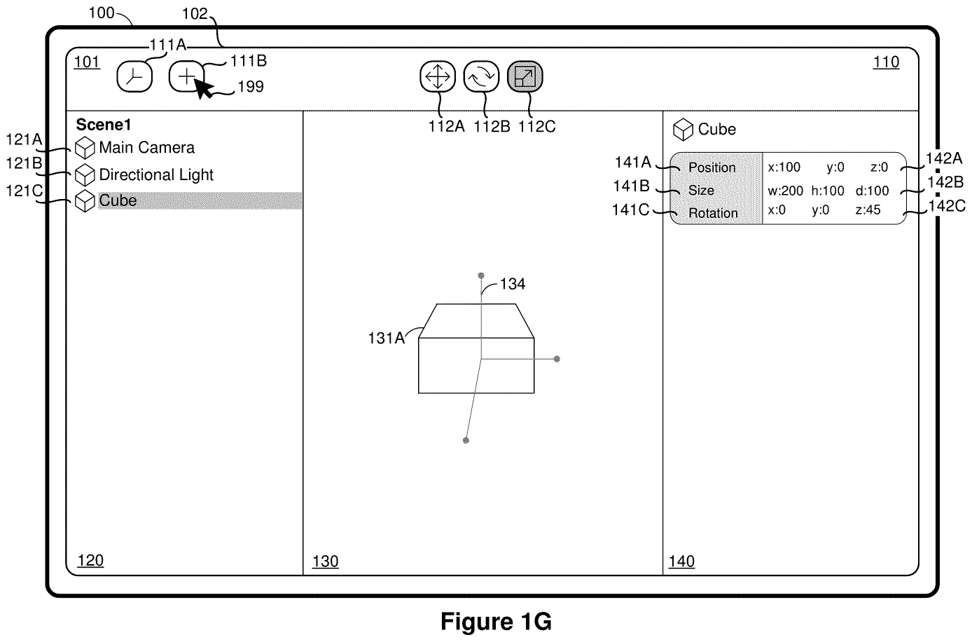

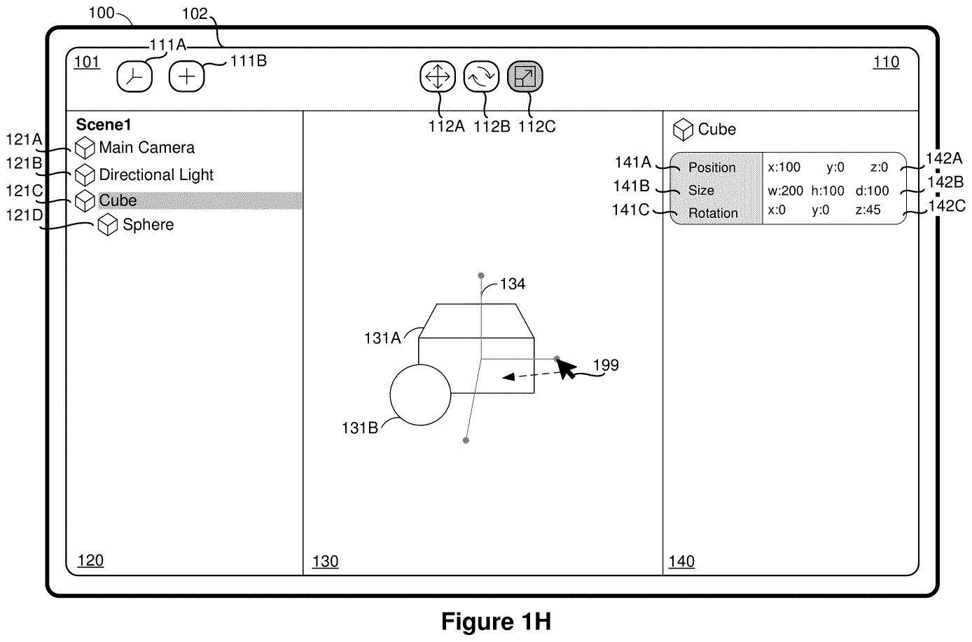

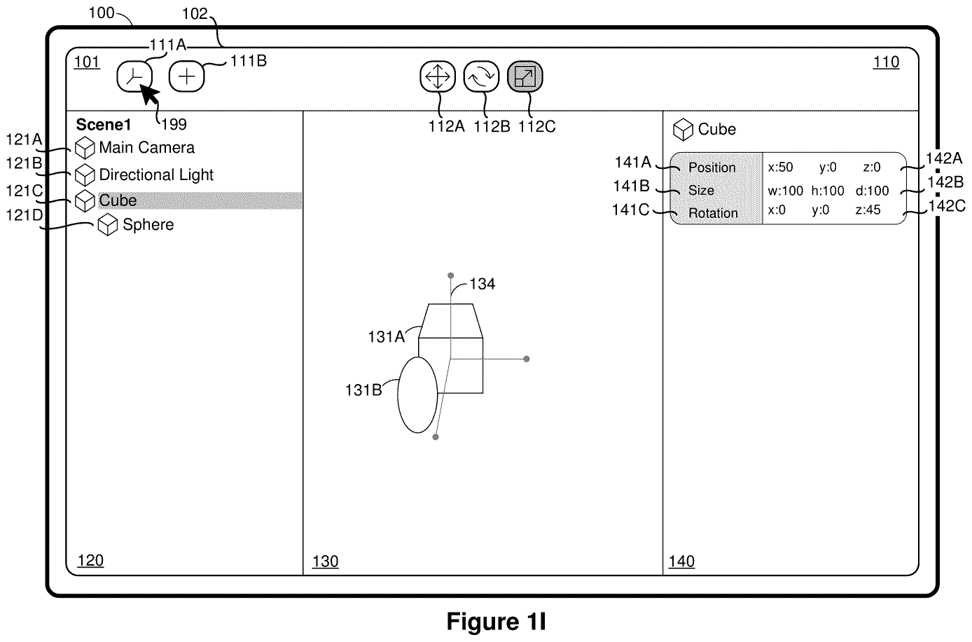

FIGS. 1A-1I illustrate an electronic device 100 including a display 102. Rendered on the display 102 is a scene composing user interface 101 that facilitates the composition of a scene including one or more objects. The scene composing user interface 101 includes a toolbar region 110, a hierarchy region 120, a preview region 130, and an inspector region 140. The scene composing user interface 101 further includes a cursor 199 for selecting various user interface elements of the scene composing user interface 101.

The toolbar region 110 includes a new scene affordance 111A which, when selected, opens a new scene. In various implementations, upon selection of the new scene affordance 111A, a window is displayed allowing a user to select various options for the new scene. The toolbar region 110 includes an add object affordance 111B which, when selected, adds an object to the currently opened scene. In various implementations, upon selection of the add object affordance 111B, a window is displayed allowing a user to select the object to be added to the currently opened scene.

The toolbar region 110 includes a position manipulation affordance 112A which, when selected, sets a manipulation mode of the scene composing user interface 101 to a position manipulation mode. While in the position manipulation mode, interactions with a representation of an object in the preview region 130 change a position of the object. The toolbar region 110 includes a rotation manipulation affordance 112B which, when selected, sets the manipulation mode of the scene composing user interface 101 to a rotation manipulation mode. While in the rotation manipulation mode, interactions with a representation of an object in the preview region 130 change a rotation of the object. The toolbar region 110 includes a size manipulation affordance 112C which, when selected, sets the manipulation mode of the scene composing user interface 101 to a size manipulation mode. While in the size manipulation mode, interactions with a representation of an object in the preview region 130 change a size of the object.

Additional functionality of the affordances of the toolbar region 110 are described further below. Further, although certain affordances of the toolbar region 110 are illustrated in FIGS. 1A-1I, it is to be appreciated that the toolbar region 110 can include other affordances with other functions.

The hierarchy region 120 includes textual representations of the objects of the currently opened scene arranged in a hierarchy, in which child objects of parent objects are displayed in association with their respective parent object and with an indication that a respective child object is a child object of the respective parent object. In FIGS. 1A-1I, a first scene is opened in the scene composing user interface 101. In FIG. 1A, the hierarchy region 120 includes a textual representation of a main camera object of the first scene 121A and a textual representation of a directional light object of the first scene 121B.

The preview region 130 includes graphical representations of the objects of the currently opened scene. In FIG. 1A, the preview region 130 is blank as there are no visible objects of the first scene.

The inspector region 140 includes indications of properties of a selected object and indications of the values of those properties. In FIG. 1A, the inspector region 140 is blank as there is no object selected.

FIGS. 1A-1I illustrate the electronic device 100 (and the displayed scene composing user interface 101) during a series of time periods. In various implementations, each time period is an instant, a fraction of a second, a few seconds, a few hours, a few days, or any length of time.

FIG. 1A illustrates the electronic device 100 during a first time period. During the first time period, the cursor 199 is displayed over the add object affordance 111B within the toolbar region 110.

FIG. 1B illustrates the electronic device 100 during a second time period subsequent to the first time period. Between the first time period and the second time period, the add object affordance 111B has been selected to add a cube object to the scene. Thus, during the second time period, the hierarchy region 120 includes a textual representation of the cube object 121C. Further, during the second time period, the preview region 130 includes a graphical representation of the cube object 131A. The textual representation of the cube object 121C is displayed in a different manner than the textual representations of the other object to indicate that the cube object is selected. For example, in FIG. 1B, the graphical representation of the cube object 121C is displayed with a gray background rather than a white background. Further, the graphical representation of the cube object 131A is displayed with a manipulator to indicate that the cube object is selected. In particular, because the manipulation mode of the scene composing user interface 101 is set to a position manipulation mode, the graphical representation of the cube object 131A is displayed with a position manipulator 132 to indicate that the cube object is selected. The position manipulation affordance 112A is displayed in a different manner than the other manipulation affordances to indicate that the scene composing user interface 101 is set to the position manipulation mode. In particular, in FIG. 1B, the position manipulation affordance 112A is displayed with a gray background rather than a white background.

Because the cube object is selected, the inspector region 140 includes indications of properties of the cube object and indications of values of those properties. For example, in FIG. 1B, the inspector region 140 includes an indication of a position property of the cube object 141A, an indication of a size property of the cube object 141B, and an indication of a rotation property of the cube object 141C. In respective association, the inspector region includes an indication of the value of the position property of the cube object 142A, an indication of the value of the size property of the cube object 142B, and an indication of the value of the rotation property of the cube object 142C.

Although only a few property of the cube object are illustrated in FIG. 1B, it is to be appreciated that the inspector region 140 can includes indications of other properties and indications of their values. For example, in various implementations, the inspector region 140 can include indications of a color or opacity of the cube object.

During the second time period, the value of the position property of the cube object (as indicated by the indication of the value of the position property of the cube object 142A) is “x:0 y:0 z:0” indicating that the cube object is centered at the origin of a three-dimensional coordinate system of the first scene. During the second time period, the value of the size property of the cube object (as indicated by the indication of the value of the size property of the cube object 142B) is “w:100 h:100 d:100” indicating that the cube object has a width, height, and depth of 100 units. During the second time period, the value of the rotation property of the cube object (as indicated by the indication of the value of the rotation property of the cube object 142C) is “x:0 y:0 z:0” indicating that the cube object is not rotated with respect to any of the axes of the three-dimensional coordinate system of the first scene.

The cube object has a three-dimensional coordinate system that is related to the three-dimensional coordinate system of the first scene via a transform. The position manipulator 132 includes three arrows pointing in the directions of the three axes of the three-dimensional coordinate system of the cube object. By interacting with the position manipulator 132 (e.g., using the cursor 199), the position of the cube object in the three-dimensional coordinate system of the first scene can be changed. In particular, by interacting with a particular arrow of the position manipulator 132, the position of the cube object in the direction of the particular arrow can be changed. During the second time period, the cursor 199 is displayed over a particular arrow of the position manipulator 132.

FIG. 1C illustrates the electronic device 100 during a third time period subsequent to the second time period. Between the second time period and the third time period, the cursor 199 has interacted with the position manipulator 132 to change the position of the cube object. Thus, during the third time period as compared to the second time period, the graphical representation of the cube object 131A is moved. Further, during the third time period, the value of the position property of the cube object (as indicated by the indication of the value of the position property of the cube object 142A) is changed to “x:50 y:0 z:0” indicating that that the cube object has moved 50 units along the x-axis of the three-dimensional coordinate system of the first scene. Because the graphical representation of the cube object 131A has moved, the position manipulator 132 has correspondingly moved to be centered in the three-dimensional coordinate system of the cube object. During the third time period, the cursor 199 is displayed over the rotation manipulation affordance 112B.

FIG. 1D illustrates the electronic device 100 during a fourth time period subsequent to the third time period. Between the third time period and the fourth time period, the rotation manipulation affordance 112B has been selected to set the manipulation mode of the scene composing user interface 101 to a rotation manipulation mode. Thus, in FIG. 1D, the rotation manipulation affordance 112B is displayed with a gray background (and the position manipulation affordance 112A has reverted to a white background). Further, the position manipulator 132 is replaced with a rotation manipulator 133.

The rotation manipulator 133 includes three circles within planes perpendicular to the three axes of the three-dimensional coordinate system of the cube object. By interacting with the rotation manipulator 133 (e.g., using the cursor 199), the rotation of the cube object in the three-dimensional coordinate system of the first scene can be changed. In particular, by interacting with a particular circle of the rotation manipulator 133, the rotation of the cube object around the corresponding axes can be changed. During the fourth time period, the cursor 199 is displayed over a particular circle of the rotation manipulator 133.

FIG. 1E illustrates the electronic device 100 during a fifth time period subsequent to the fourth time period. Between the fourth time period and the fifth time period, the cursor 199 has interacted with the rotation manipulator 133 to change the rotation of the cube object. Thus, during the fifth time period as compared to the fourth time period, the graphical representation of the cube object 131A is rotated. Further, during the fifth time period, the value of the rotation property of the cube object (as indicated by the indication of the value of the rotation property of the cube object 142C) is changed to “x:0 y:0 z:45” indicating that that the cube object has rotated 45 units around the z-axis of the three-dimensional coordinate system of the first scene. During the fifth time period, the cursor 199 is displayed over the size manipulation affordance 112C.

FIG. 1F illustrates the electronic device 100 during a sixth time period subsequent to the fifth time period. Between the fifth time period and the sixth time period, the size manipulation affordance 112C has been selected to set the manipulation mode of the scene composing user interface 101 to a size manipulation mode. Thus, in FIG. 1F, the size manipulation affordance 112C is displayed with a gray background (and the rotation manipulation affordance 112B has reverted to a white background). Further, the rotation manipulator 133 is replaced with a size manipulator 134.

The size manipulator 134 includes three circle-terminated lines pointing in the direction of the three axes of the three-dimensional coordinate system of the cube object. By interacting with the size manipulator 134 (e.g., using the cursor 199), the size of the cube object in the three-dimensional coordinate system of the first scene can be changed. In particular, by interacting with a particular line of the size manipulator 134, the size of the cube object in the direction of the line can be changed. Thus, by interacting with a width line of the size manipulator 134, the width of the cube object can be changed. Similarly, by interacting with a height line of the size manipulator 134, the height of the cube object can be changed and by interacting with a depth line of the size manipulator 134, the depth of the cube object can be changed. During the sixth time period, the cursor 199 is displayed over the width line of the size manipulator 134.

FIG. 1G illustrates the electronic device 100 during a seventh time period subsequent to the sixth time period. Between the sixth time period and the seventh time period, the cursor 199 has interacted with the width line of the size manipulator 134 to change the width of the cube object. Thus, during the seventh time period as compared to the sixth time period, the graphical representation of the cube object 131A is wider. Further, during the seventh time period, the value of the size property of the cube object (as indicated by the indication of the value of the size property of the cube object 142B) is changed to “w:200 h:100 d:100” indicating that that the cube object is twice as wide in the three-dimensional coordinate system of the cube object. In various implementations, when the size of an object is changed, both sides of the object change position and the center remains stationary. In various implementations, when the size of an object is changed, one side of the object changes position and the center moves in the direction of the size increase or decrease. Thus, during the seventh time period, the value of the position property of the cube object (as indicated by the indication of the value of the position property of the cube object 142A) is changed to “x:100 y:0 z:0” indicating that the center of the cube object has moved to the right 50 units (half of the change in width). During the seventh time period, the cursor 199 is displayed over the add object affordance 111B.

FIG. 1H illustrates the electronic device 100 during an eighth time period subsequent to the seventh time period. Between the seventh time period and the eighth time period, the add object affordance 111B has been selected to add a sphere object to the scene. The sphere object is a child object of the cube object and is located at a position in the three-dimensional coordinate system of the cube object (e.g., the front, left, lower corner of the cube object). In response to adding the sphere object to the scene, the hierarchy region 120 includes a textual representation of the sphere object 121D in association with the textual representation of the cube object 121C. Further, the textual representation of the sphere object 121D indicates that the sphere object is a child object of the cube object. In particular, the textual representation of the sphere object 121D is indented with respect to the textual representation of the cube object 121C. In response to adding the sphere object to the scene, the preview region 130 includes a graphical representation of the sphere object 131B. Because the cube object remains selected, the inspector region 140 is unchanged. During the eighth time period, the cursor 199 is displayed over the width line of the size manipulator 134.

FIG. 1I illustrates the electronic device 100 during a ninth time period subsequent to the eighth time period. Between the eighth time period and the ninth time period, the cursor 199 has interacted with the width line of the size manipulator 134 to change the width of the cube object. Thus, during the ninth time period as compared to the eighth time period, the graphical representation of the cube object 131A is narrower. Further, during the ninth time period, the value of the size property of the cube object (as indicated by the indication of the value of the size property of the cube object 142B) is changed to “w:100 h:100 d:100” indicating that that the cube object is half as wide in the three-dimensional coordinate system of the cube object.

As a child object of the cube object, when the position of the cube object in the three-dimensional coordinate system is changed, the position of the sphere object in the three-dimensional coordinate system of the first scene is correspondingly changed to maintain the position of the sphere object in the three-dimensional coordinate system of the cube object. Further, when the rotation of the cube object in the three-dimensional coordinate system of the first scene is changed, the rotation (and, potentially, position) of the sphere object in the three-dimensional coordinate system of the first scene is correspondingly changed to maintain the rotation and position of the sphere object in the three-dimensional coordinate system of the cube object. Further, when the size of the cube object is changed, the size of the sphere object is proportionally changed to maintain the proportions of the sphere object with respect to the cube object. Thus, during the ninth time period as compared to the eighth time period, the graphical representation of the sphere object 131B is narrower. When the size of the cube object is changed, the position of the sphere object in the three-dimensional coordinate system of the cube object is proportionally changed to maintain the location of the sphere object on the front, left, lower corner of the sphere object. During the ninth time period, the cursor 199 is displayed over the new scene affordance 111A.

In various implementations, it may be disadvantageous for a child object to change size proportionally to a change in size of a parent object. Accordingly, in various implementations, an object is associated with a construction plan that indicates a corresponding size of a child object for various sizes of the parent object. In particular, in various implementations, the construction plan indicates the size of a child object in a particular dimension for various sizes of the parent object in the particular dimension. In various implementations, the construction plan indicates allowable sizes for the parent object (and the corresponding size of the child object for each allowable size). In various implementations, the construction plan indicates the position of the child object in the three-dimensional coordinate system of the parent object for various sizes of the parent object. In various implementations, the construction plan may indicate if the child object is visible or invisible (or, alternatively, present or not present) for various sizes of the parent object.

In various implementations, the construction plan parameters for a child object are defined via a look-up table for various sizes of the parent object. In various implementations, the construction plan parameters for a child object are defined algorithmically for various sizes of the parent object.

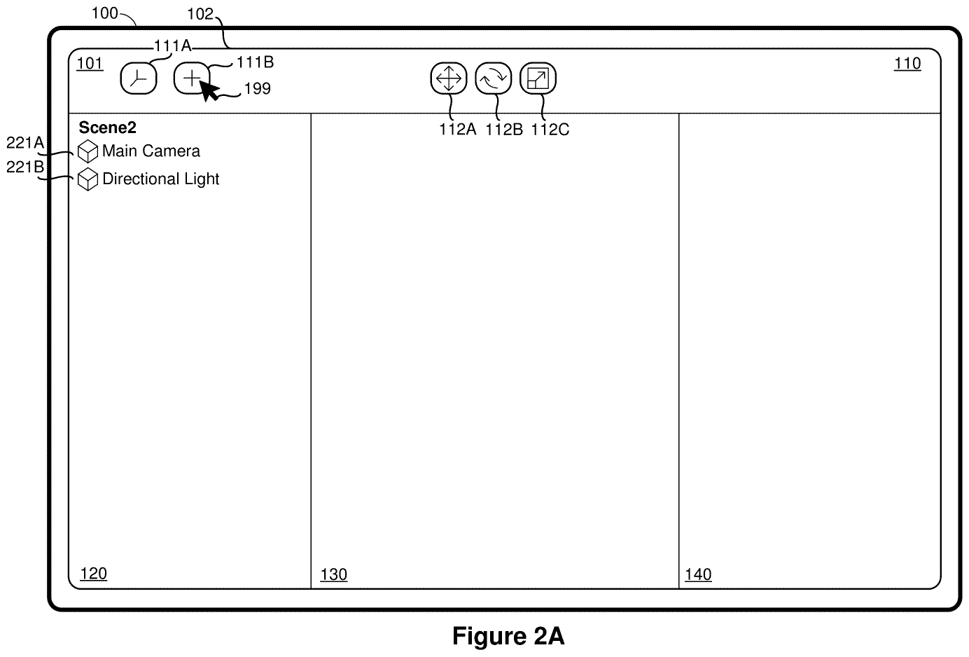

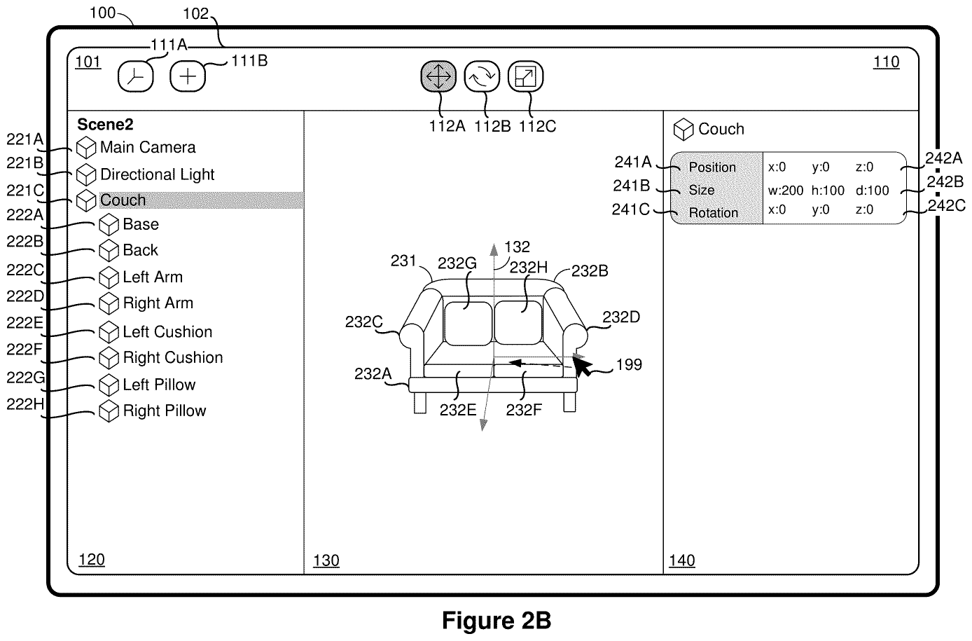

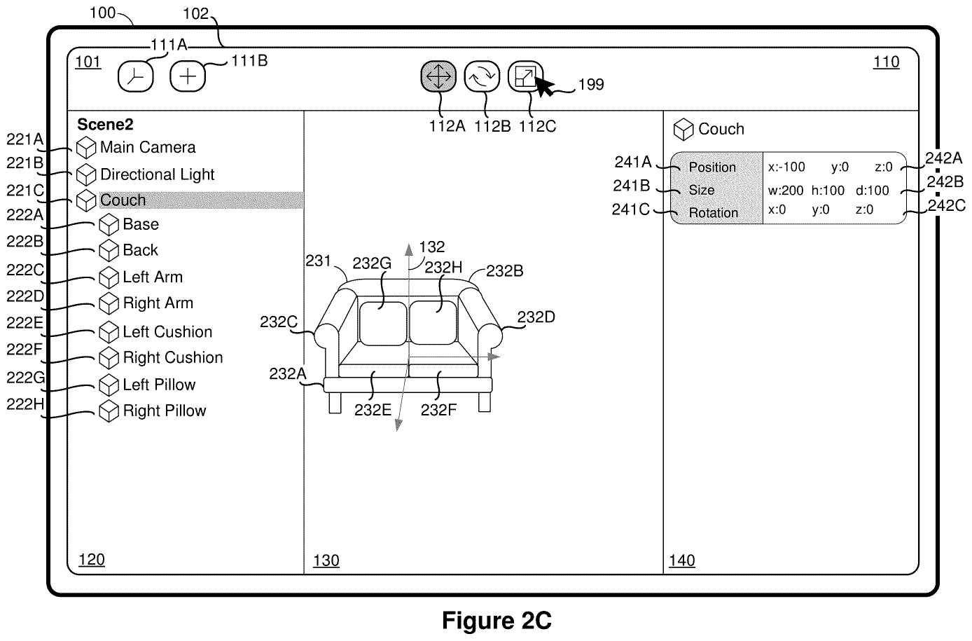

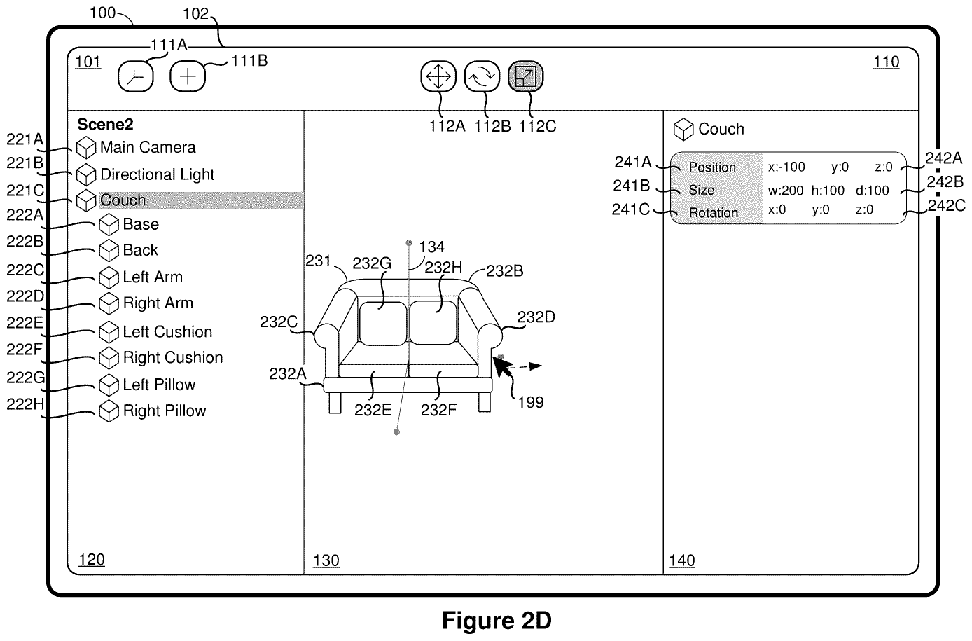

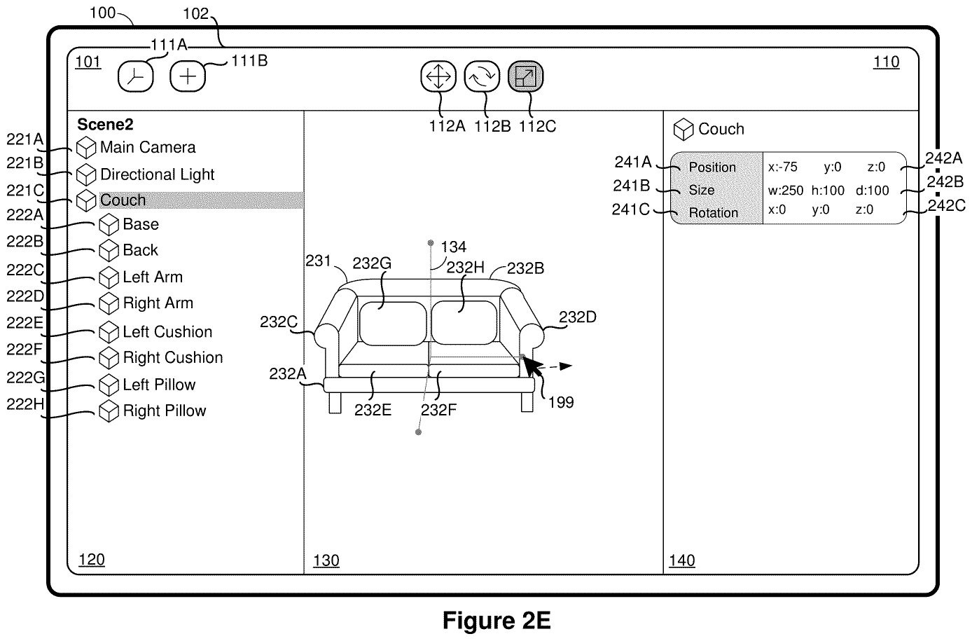

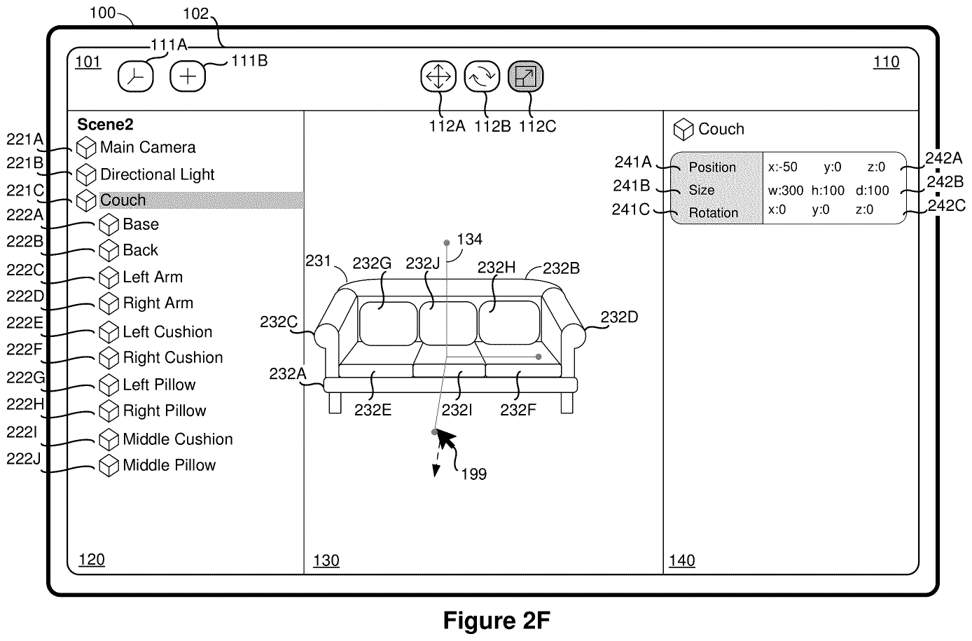

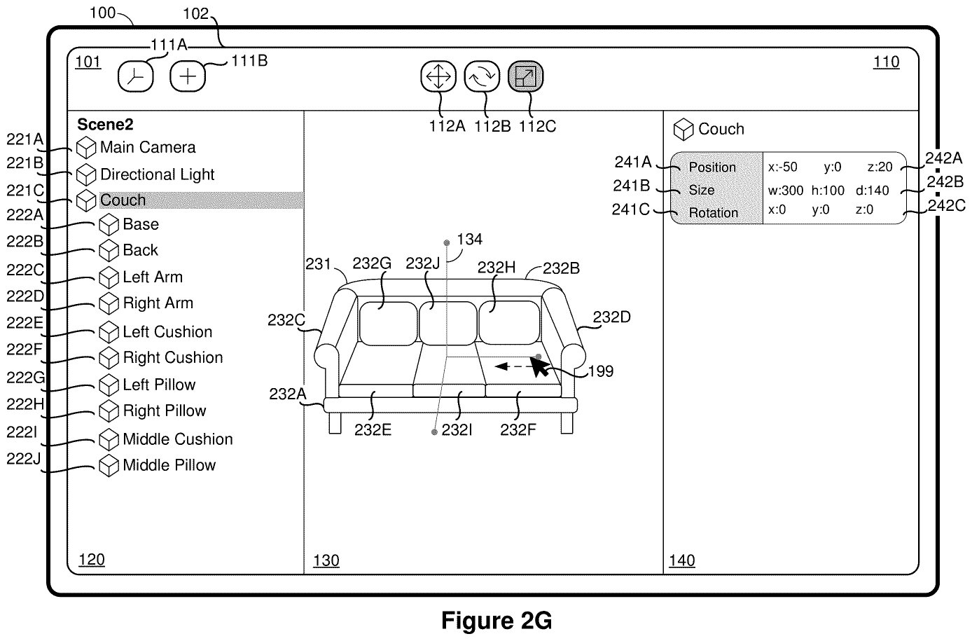

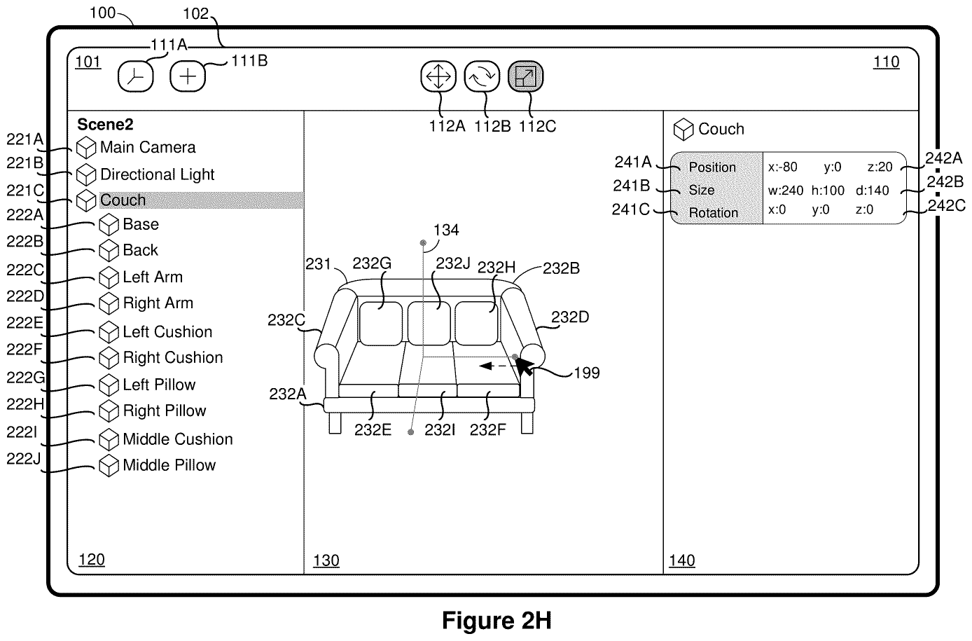

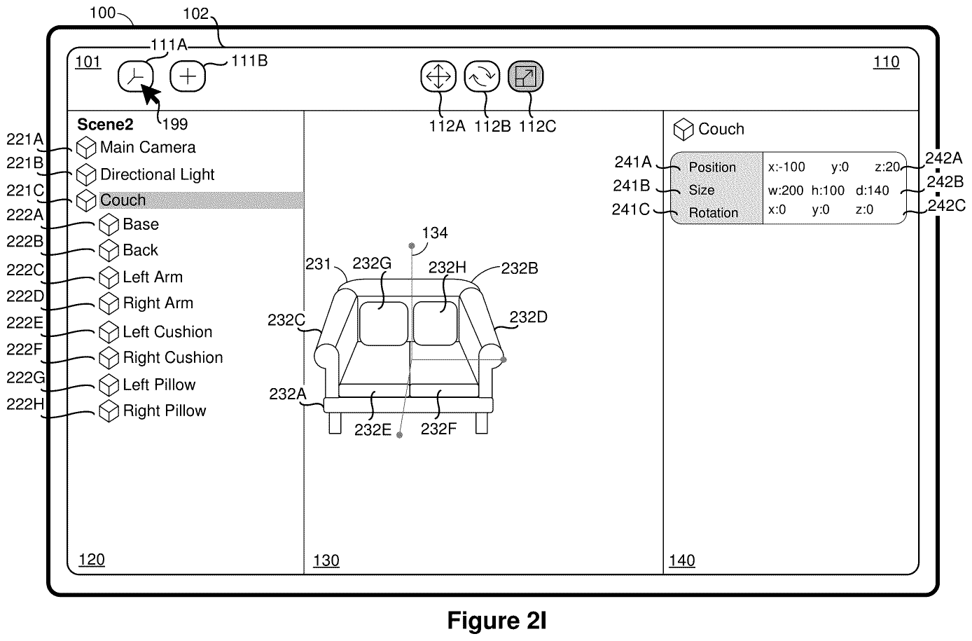

FIGS. 2A-2I illustrate the electronic device 100 displaying the scene composing user interface 101 of FIGS. 1A-1I with a second scene opened during a series of time periods. For ease of explanation, the numbering of time periods will be reset with the change from FIGS. 1A-1I to FIGS. 2A-2I.

FIG. 2A illustrates the electronic device 100 during a first time period. In FIG. 2A, the hierarchy region 120 includes a textual representation of a main camera object of the second scene 221A and a textual representation of a directional light object of the second scene 221B. In FIG. 2A, the preview region 130 is blank as there are no visible objects of the second scene. In FIG. 2A, the inspector region 140 is blank as there is no object selected. During the first time period, the cursor 199 is displayed over the add object affordance 111B within the toolbar region 110.

FIG. 2B illustrates the electronic device 100 during a second time period subsequent to the first time period. Between the first time period and the second time period, the add object affordance 111B has been selected to add a couch object to the scene. Thus, during the second time period, the hierarchy region 120 includes a textual representation of the couch object 221C. Further, during the second time period, the preview region 130 includes a graphical representation of the couch object 231. The textual representation of the couch object 221C is displayed in a different manner than the textual representations of the other objects to indicate that the couch object is selected. For example, in FIG. 2B, the textual representation of the couch object 221C is displayed with a gray background rather than a white background. Further, the graphical representation of the couch object 231 is displayed with a manipulator to indicate that the couch object is selected. In particular, because the manipulation mode of the scene composing user interface 101 is set to the position manipulation mode, the graphical representation of the couch object 231 is displayed with a position manipulator 132 to indicate that the couch object is selected. The position manipulation affordance 112A is displayed in a different manner than the other manipulation affordances to indicate that the scene composing user interface 101 is set to the position manipulation mode. In particular, in FIG. 2B, the position manipulation affordance 112A is displayed with a gray background rather than a white background.

Because the couch object is selected, the inspector region 140 includes indications of properties of the couch object and indications of values of those properties. For example, in FIG. 2B, the inspector region 140 includes an indication of a position property of the couch object 241A, an indication of a size property of the couch object 241B, and an indication of a rotation property of the couch object 241C. In respective association, the inspector region 140 includes an indication of the value of the position property of the couch object 242A, an indication of the value of the size property of the couch object 242B, and an indication of the value of the rotation property of the couch object 242C.

During the second time period, the value of the position property of the couch object (as indicated by the indication of the value of the position property of the couch object 242A) is “x:0 y:0 z:0” indicating that the couch object is centered at the origin of a three-dimensional coordinate system of the second scene. During the second time period, the value of the size property of the couch object (as indicated by the indication of the value of the size property of the couch object 242B) is “w:200 h:100 d:100” indicating that the couch object has a width of 200 units and a height and depth of 100 units. During the second time period, the value of the rotation property of the couch object (as indicated by the indication of the value of the rotation property of the couch object 242C) is “x:0 y:0 z:0” indicating that the couch object is not rotated with respect to any of the axes of the three-dimensional coordinate system of the second scene.

The couch object is the parent object of a number of child objects, including a base object, a back object, a left arm object, a right arm object, a left cushion object, a right cushion object, a left pillow object, and a right pillow object. Accordingly, the hierarchy region 120 includes a textual representation of the base object 222A, a textual representation of the back object 222B, a textual representation of the left arm object 222C, a textual representation of the right arm object 222D, a textual representation of the left cushion object 222E, a textual representation of the right cushion object 222F, a textual representation of the left pillow object 222G, and a textual representation of the right pillow object 222H, each in association with the textual representation of the couch object 221C and indicating (e.g., via indentation) that the corresponding object is child object of the couch object. Further, the graphical representation of the couch object 231 includes a graphical representation of the base object 232A, a graphical representation of the back object 232B, a graphical representation of the left arm object 232C, a graphical representation of the right arm object 232D, a graphical representation of the left cushion object 232E, a graphical representation of the right cushion object 232F, a graphical representation of the left pillow object 232G, and a graphical representation of the right pillow object 232H. In various implementations, the couch object is an empty object. Thus, the graphical representation of the couch object 231 is the aggregate of the graphical representations of the child objects. Each of the child objects of the couch object is associated with a size and a position in a three-dimensional coordinate system of the couch object that is related to the three-dimensional coordinate system of the second scene via a transform. During the second time period, the cursor 199 is display over a particular arrow of the position manipulator 132.

FIG. 2C illustrates the electronic device 100 during a third time period subsequent to the second time period. Between the second time period and the third time period, the cursor 199 has interacted with the position manipulator 132 to change the position of the couch object. Thus, during the third time period as compared to the second time period, the graphical representation of the couch object 231 is moved. Further, during the third time period, the value of the position property of the couch object (as indicated by the indication of the value of the position property of the couch object 242A) is changed to “x:−100 y:0 z:0” indicating that that the cube object has moved 100 units to the left. Because the couch object has moved, each of the child objects of the couch object is correspondingly moved. Similarly, because the graphical representation of the couch object 231 is moved, each of the graphical representations of the child objects (and the position manipulator 132) are correspondingly moved. During the third time period, the cursor 199 is displayed over the size manipulation affordance 112C.

FIG. 2D illustrates the electronic device 100 during a fourth time period subsequent to the third time period. Between the third time period and the fourth time period, the size manipulation affordance 112C has been selected to set the manipulation mode of the scene composing user interface 101 to the size manipulation mode. Thus, in FIG. 2D, the size manipulation affordance 112C is displayed with a gray background (and the position manipulation affordance 112A has reverted to a white background). Further, the position manipulator 132 is replaced with the size manipulator 134. During the fourth time period, the cursor 199 is located over the width line of the size manipulator 134.

FIG. 2E illustrates the electronic device 100 during a fifth time period subsequent to the fourth time period. Between the fourth time period and the fifth time period, the cursor 199 has interacted with the width line of the size manipulator 134 to change the width of the couch object. Thus, during the fifth time period as compared to the fourth time period, the graphical representation of the couch object 231 is wider. Further, during the fifth time period, the value of the size property of the couch object (as indicated by the indication of the value of the size property of the couch object 242B) is changed to “w:250 h:100 d:100” indicating that that the couch object is 50 units wider in the three-dimensional coordinate system of the couch object. In various implementations, when the size of an object is changed, both sides of the object change position and the center remains stationary. In various implementations, when the size of an object is changed, one side of the object changes position and the center moves in the direction of the size increase or decrease. Thus, during the fifth time period, the value of the position property of the couch object (as indicated by the indication of the value of the position property of the couch object 242A) is changed to “x:−75 y:0 z:0” indicating that the center of the couch object has moved to the right 25 units (half of the change in width).

In the absence of a construction plan, when the width of the couch object increases by 25 percent, each of the child objects would similarly increase in width by 25 percent. However, due the construction plan for the couch object, this does not occur. Rather, in response to the width of the couch object increasing by 25 percent, the back object and the base object increase in width by 25 percent, but the left arm object and the right arm object do not increase in width at all. Further, the left cushion object, the right cushion object, the left pillow object, and the right pillow object increase in width by more than 25 percent (e.g., such that the total width of the left arm object, the left cushion object, the right cushion object, and the right arm object is the width of the couch object).

In the absence of a construction plan, when the width of the couch object increases by 25 percent, the position in the corresponding dimension of the three-dimensional coordinate system of the couch object of each child object would similarly increase by 25 percent. However, due the construction plan for the couch object, this does not occur. Rather, in response to the width of the couch object increasing by 25 percent, the position in the corresponding dimension of the three-dimensional coordinate system of the couch object of the left arm object, the right arm object, the left cushion object, the right cushion object, the left pillow object, and the right pillow object are increased by more than 25 percent. Because the base object and back object are centered in the corresponding dimension of the three-dimensional coordinate system of the couch object, their position is unchanged by the change in width.

Thus, during the fifth time period as compared to the fourth time period, the graphical representation of the base object 232A and the graphical representation of the back object 232B are 25 percent wider and unmoved in the three-dimensional coordinate system of the couch object; the graphical representation of the left arm object 232C and the graphical representation of the right arm object 232D are unchanged in size but moved more than 25 percent further from the origin of the three-dimensional coordinate system of the couch object; and the graphical representation of the left cushion object 232E, the graphical representation of the right cushion object 232F, the graphical representation of the left pillow object 232G, and the graphical representation of the right pillow object 232H are more than 25 percent wider and moved more than 25 percent further from the origin of the three-dimensional coordinate system of the couch object. During the fifth time period, the cursor 199 is displayed over the width line of the size manipulator 134.

FIG. 2F illustrates the electronic device 100 during a sixth time period subsequent to the fifth time period. Between the fifth time period and the sixth time period, the cursor 199 has interacted with the width line of the size manipulator 134 to change the width of the couch object. Thus, during the sixth time period as compared to the fifth time period, the graphical representation of the couch object 231 is wider. Further, during the sixth time period, the value of the size property of the couch object (as indicated by the indication of the value of the size property of the couch object 242B) is changed to “w:300 h:100 d:100” indicating that that the couch object is 50 units wider in the three-dimensional coordinate system of the couch object. In various implementations, when the size of an object is changed, both sides of the object change position and the center remains stationary. In various implementations, when the size of an object is changed, one side of the object changes position and the center moves in the direction of the size increase or decrease. Thus, during the sixth time period, the value of the position property of the couch object (as indicated by the indication of the value of the position property of the couch object 242A) is changed to “x:−50 y:0 z:0” indicating that the center of the couch object has moved to the right 25 units (half of the change in width).

Similar to above, in the absence of a construction plan, when the width of the couch object increases by 20 percent, each of the child objects similarly increases in width by 20 percent. However, due the construction plan for the couch object, this does not occur. Rather, in response to the width of the couch object increasing by 20 percent, the back object and the base object increase in width by 20 percent, but the left arm object and the right arm object do not increase in width at all. Further, the left cushion object, the right cushion object, the left pillow object, and the right pillow object decrease in width due to the introduction of two new child objects of the couch object, a middle cushion object and a middle pillow object (e.g., such that the total width of the left arm object, the left cushion object, the middle cushion object, the right cushion object, and the right arm object is the width of the couch object).

In the absence of a construction plan, when the width of the couch object increases by 20 percent, the position in the corresponding dimension of the three-dimensional coordinate system of the couch object of each child object similarly increases by 20 percent. However, due the construction plan for the couch object, this does not occur. Rather, in response to the width of the couch object increasing by 20 percent, the position in the corresponding dimension of the three-dimensional coordinate system of the couch object of the left arm object, the right arm object, the left cushion object, right cushion object, left pillow object, and right pillow object are increased by more than 20 percent (e.g., to make room for the middle cushion object and middle pillow object such that the cushion objects). Because the base object and back object are centered in the corresponding dimension of the three-dimensional coordinate system of the couch object, their position is unchanged by the change in width.

When the width of the couch object increases to a value greater than a first threshold, the couch object includes, as child objects, the middle cushion object and the middle pillow object. Accordingly, the hierarchy region 120 includes a textual representation of the middle cushion object 222I and a textual representation of the middle pillow object 222J and the preview region 130 includes a graphical representation of the middle cushion object 232I and a graphical representation of the middle pillow object 232J.

During the sixth time period as compared to the fifth time period, the graphical representation of the base object 232A and the graphical representation of the back object 232B are 20 percent wider; the graphical representation of the left arm object 232C and the graphical representation of the right arm object 232D are unchanged in size but moved in the corresponding dimension more than 20 percent further from the origin of the three-dimensional coordinate system of the couch object; and the graphical representation of the left cushion object 232E, the graphical representation of the right cushion object 232F, the graphical representation of the left pillow object 232G, and the graphical representation of the right pillow object 232H are narrower and moved in the corresponding dimension more than 20 percent further form the origin of the three-dimensional coordinate system of the couch object. Further, the graphical representation of the couch object 231 includes a graphical representation of the middle cushion object 232I and a graphical representation of the middle pillow object 232J. During the sixth time period, the cursor 199 is displayed over the depth line of the size manipulator 134.

FIG. 2G illustrates the electronic device 100 during a seventh time period subsequent to the sixth time period. Between the sixth time period and the seventh time period, the cursor 199 has interacted with the depth line of the size manipulator 134 to change the depth of the couch object. Thus, during the seventh time period as compared to the sixth time period, the graphical representation of the couch object 231 is deeper. Further, during the seventh time period, the value of the size property of the couch object (as indicated by the indication of the value of the size property of the couch object 242B) is changed to “w:300 h:100 d:140” indicating that that the couch object is 40 units deeper in the three-dimensional coordinate system of the couch object. In various implementations, when the size of an object is changed, both sides of the object change position and the center remains stationary. In various implementations, when the size of an object is changed, one side of the object changes position and the center moves in the direction of the size increase or decrease. Thus, during the seventh time period, the value of the position property of the couch object (as indicated by the indication of the value of the position property of the couch object 242A) is changed to “x:−50 y:0 z:20” indicating that the center of the couch object has moved forward 20 units (half of the change in depth).

In the absence of a construction plan, when the depth of the couch object increases by 40 percent, each of the child objects similarly increases in depth by 40 percent. However, due the construction plan for the couch object, this does not occur. Rather, in response to the depth of the couch object increasing by 40 percent, the base object increases in depth by 40 percent, but the back object, the left pillow object, the middle pillow object, and the right pillow object do not increase in depth at all. Further, the left arm object, the right arm object, the left cushion object, the middle cushion object, and the right cushion object increase in depth more than 40 percent (e.g., such that the total depth of the back object and the left arm object is the depth of the couch object).

In the absence of a construction plan, when the depth of the couch object increases by 40 percent, the position in the corresponding dimension of the three-dimensional coordinate system of the couch object of each child object similarly increases by 40 percent. However, due the construction plan for the couch object, this does not occur. Rather, in response to the depth of the couch object increasing by 40 percent, the position in the corresponding dimension of the three-dimensional coordinate system of the couch object of the back object, the left pillow object, the middle pillow object, and the right pillow object is increased by more than 40 percent and the position in the corresponding dimension of the three-dimensional coordinate system of the couch object of the left cushion object, middle cushion object, and right cushion object is unchanged. Because the other objects are centered in the corresponding dimension of the three-dimensional coordinate system of the couch object, their position is unchanged by the change in depth.

During the seventh time period as compared to the sixth time period, the graphical representation of the base object 232A is 40 percent deeper and unmoved in the corresponding dimension of the three-dimensional coordinate system of the couch object; the graphical representation of the back object 232B, the graphical representation of the left pillow object 232G, the graphical representation of the middle pillow object 232J, and the graphical representation of the right pillow object 232H are unchanged in size but moved in the corresponding dimension of the three-dimensional coordinate system of the couch object more than 40 percent further from the origin of the three-dimensional coordinate system of the couch object; and the graphical representation of the left arm object 232C, the graphical representation of the right arm object 232D, the graphical representation of the left cushion object 232E, the graphical representation of the middle cushion object 232I, and the graphical representation of the right cushion object 232F are more than 40 percent deeper and unmoved in the corresponding dimension of the three-dimensional coordinate system of the couch object. During the seventh time period, the cursor 199 is displayed over the width line of the size manipulator 134.

FIG. 2H illustrates the electronic device 100 during an eighth time period subsequent to the seventh time period. Between the seventh time period and the eighth time period, the cursor 199 has interacted with the width line of the size manipulator 134 to change the width of the couch object. Thus, during the eighth time period as compared to the seventh time period, the graphical representation of the couch object 231 is narrower. Further, during the eighth time period, the value of the size property of the couch object (as indicated by the indication of the value of the size property of the couch object 242B) is changed to “w:240 h:100 d:140” indicating that that the couch object is 60 units narrower in the three-dimensional coordinate system of the couch object. In various implementations, when the size of an object is changed, both sides of the object change position and the center remains stationary. In various implementations, when the size of an object is changed, one side of the object changes position and the center moves in the direction of the size increase or decrease. Thus, during the eighth time period, the value of the position property of the couch object (as indicated by the indication of the value of the position property of the couch object 242A) is changed to “x:−80 y:0 z:20” indicating that the center of the couch object has moved left 30 units (half of the change in width).

In the absence of a construction plan, when the width of the couch object decreases by 20 percent, each of the child objects similarly decreases in width by 20 percent. However, due the construction plan for the couch object, this does not occur. Rather, in response to the width of the couch object decreasing by 20 percent, the base object and the back object decreases in depth by 20 percent, but the left arm object and the right arm object do not decrease in width at all. Further, the left cushion object, the middle cushion object, the right cushion object, the left pillow object, the middle pillow object, and the right pillow object decrease in width more than 20 percent (e.g., such that the total width of the left arm object, left cushion object, middle cushion object, right cushion object, and right arm object is the width of the couch object).

In the absence of a construction plan, when the width of the couch object decreases by 20 percent, the position in the corresponding dimension of the three-dimensional coordinate system of the couch object of each child object similarly decreases by 20 percent. However, due the construction plan for the couch object, this does not occur. Rather, in response to the width of the couch object decreasing by 20 percent, the position in the corresponding dimension of the three-dimensional coordinate system of the couch object of the left arm object, the right arm object, the left cushion object, right cushion object, left pillow object, and right pillow object are decreased by more than 20 percent. Because the base object, the back object, the middle cushion object, and the middle pillow object are centered in the corresponding dimension of the three-dimensional coordinate system of the couch object, their position is unchanged by the change in width.

Further, even though the width of the couch object during the eighth time period is less than the width of the couch object during the fifth time period of FIG. 2E, the couch object maintains (as child objects) the middle cushion object and the middle pillow object until the width of the couch object is below a second threshold (as described below).

During the eighth time period as compared to the seventh time period, the graphical representation of the base object 232A and the graphical representation of the back object 232B are 20 percent narrower and unmoved in the corresponding dimension of the three-dimensional coordinate system of the couch object; the graphical representation of the left arm object 232C and the graphical representation of the right arm object 232D are unchanged in size but moved in the corresponding dimension of the three-dimensional coordinate system of the couch object more than 20 percent closer to the origin of the three-dimensional coordinate system of the couch object; the graphical representation of the middle cushion object 232I and the graphical representation of the middle pillow object 232J are more than 20 percent narrower and unmoved in the corresponding dimension of the three-dimensional coordinate system of the couch object; and the graphical representation of the left cushion object 232E, the graphical representation of the right cushion object 232F, the graphical representation of the left pillow object 232G, and the graphical representation of the right pillow object 232H are more than 20 percent narrower and moved in the corresponding dimension of the three-dimensional coordinate system of the couch object more than 20 percent closer to the origin of the three-dimensional coordinate system of the couch object. During the eighth time period, the cursor 199 is displayed over the width line of the size manipulator 134.

FIG. 2I illustrates the electronic device 100 during a ninth time period subsequent to the eighth time period. Between the eighth time period and the ninth time period, the cursor 199 has interacted with the width line of the size manipulator 134 to change the width of the couch object. Thus, during the ninth time period, the graphical representation of the couch object 231 is narrower. Further, during the ninth time period, the value of the size property of the couch object (as indicated by the indication of the value of the size property of the couch object 242B) is changed to “w:200 h:100 d:140” indicating that that the couch object is 40 units narrower in the three-dimensional coordinate system of the couch object. In various implementations, when the size of an object is changed, both sides of the object change position and the center remains stationary. In various implementations, when the size of an object is changed, one side of the object changes position and the center moves in the direction of the size increase or decrease. Thus, during the ninth time period, the value of the position property of the couch object (as indicated by the indication of the value of the position property of the couch object 242A) is changed to “x:−100 y:0 z:20” indicating that the center of the couch object has moved left 20 units (half of the change in width).

In the absence of a construction plan, when the width of the couch object decreases by 17 percent, each of the child objects similarly decreases in width by 17 percent. However, due the construction plan for the couch object, this does not occur. Rather, in response to the width of the couch object decreasing by 17 percent, the base object and the back object decreases in width by 17 percent, but the left arm object and the right arm object do not decrease in width at all. Further, the left cushion object, the right cushion object, the left pillow object, and the right pillow object increase in width due to the removal of the middle cushion object and the middle pillow object (e.g., such that the total width of the left arm object, left cushion object, right cushion object, and right arm object is the width of the couch object).

In the absence of a construction plan, when the width of the couch object decreases by 17 percent, the position in the corresponding dimension of the three-dimensional coordinate system of the couch object of each child object similarly decreases by 17 percent. However, due the construction plan for the couch object, this does not occur. Rather, in response to the width of the couch object decreasing by 17 percent, the position in the corresponding dimension of the three-dimensional coordinate system of the couch object of the left arm object, the right arm object, the left cushion object, right cushion object, left pillow object, and right pillow object are decreased by more than 17 percent (the cushion object and pillow objects more so than the arm objects due to the removal of the middle cushion object and the middle pillow object). Because the base object and the back object are centered in the corresponding dimension of the three-dimensional coordinate system of the couch object, their position is unchanged by the change in width.

During the ninth time period as compared to the eighth time period, the graphical representation of the base object 232A and the graphical representation of the back object 232B are 17 percent narrower and unmoved in the corresponding dimension of three-dimensional coordinate system of the couch object; the graphical representation of the left arm object 232C and the graphical representation of the right arm object 232D are unchanged in size but moved in the corresponding dimension of the three-dimensional coordinate system of the couch object more than 17 percent closer to the origin of the three-dimensional coordinate system of the couch object; and the graphical representation of the left cushion object 232E, the graphical representation of the right cushion object 232F, the graphical representation of the left pillow object 232G, and the graphical representation of the right pillow object 232H are wider and moved in the corresponding dimension of the three-dimensional coordinate system of the couch object more than 17 percent closer to the origin of the three-dimensional coordinate system of the couch object. Further, the graphical representation of the middle cushion object 232I and the graphical representation of the middle pillow object 232J are absent. During the ninth time period, the cursor 199 is displayed over the new scene affordance 111A.

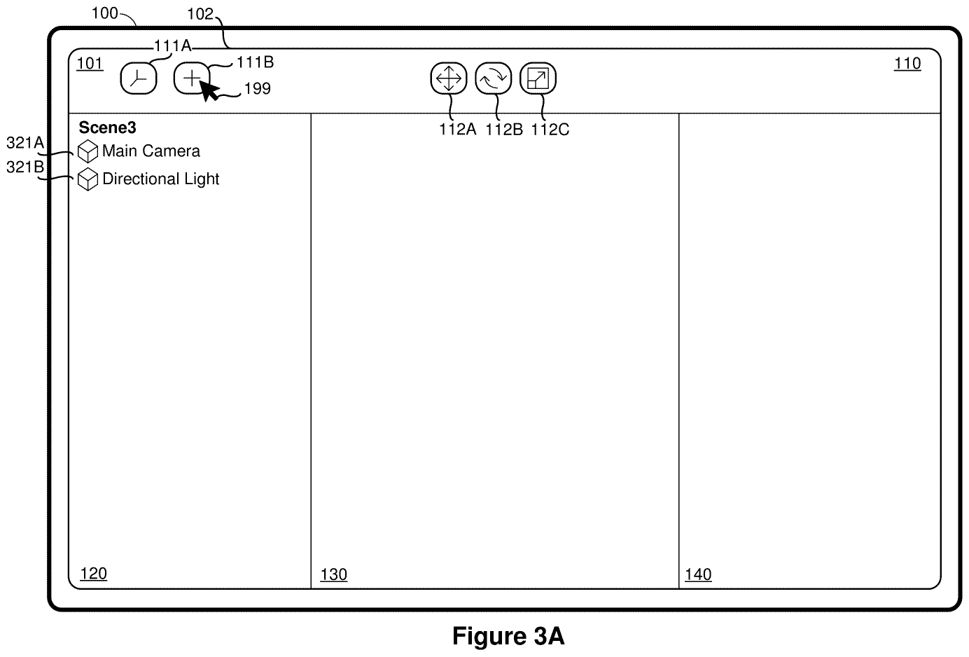

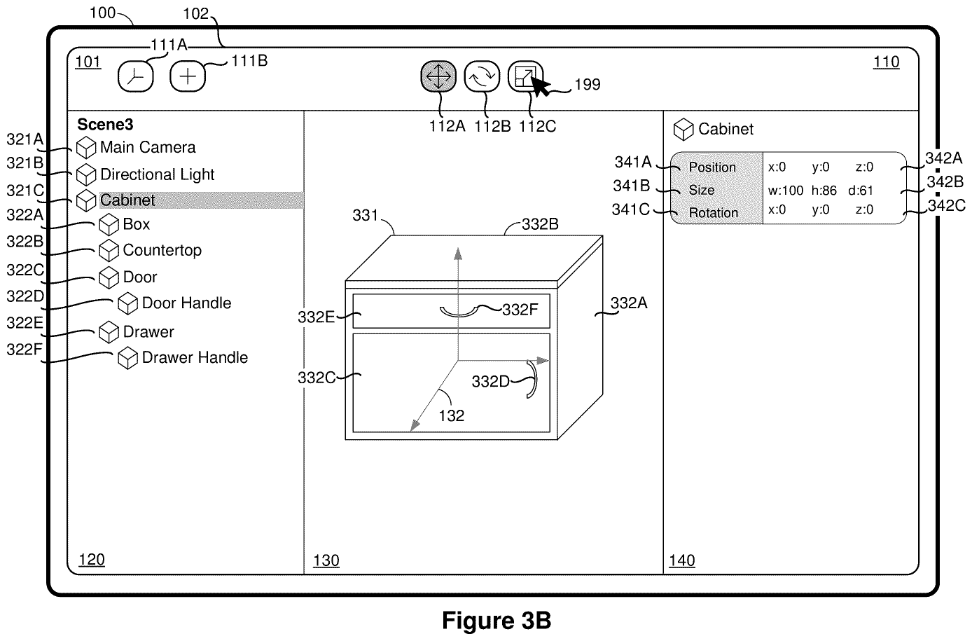

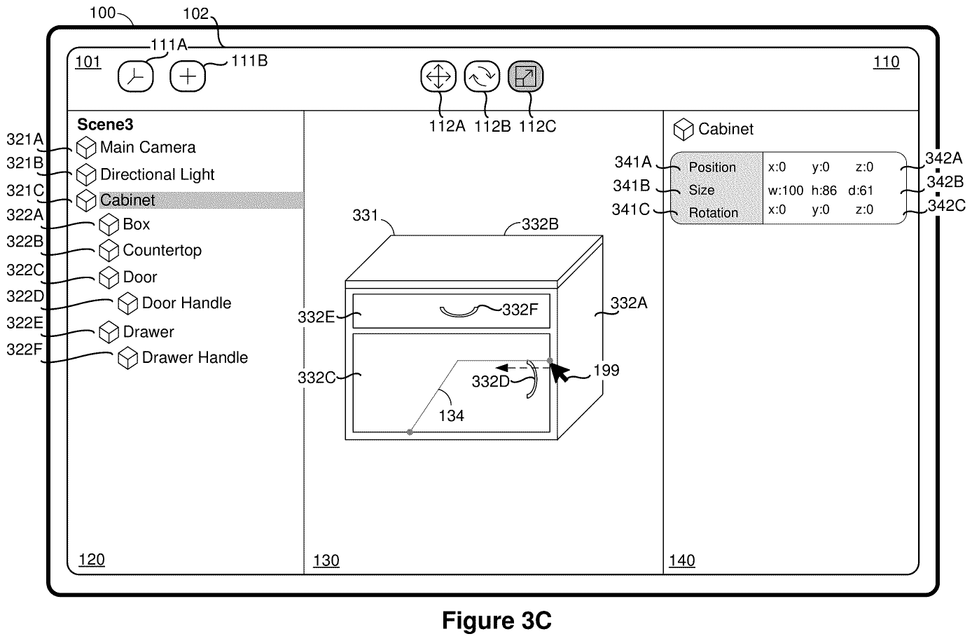

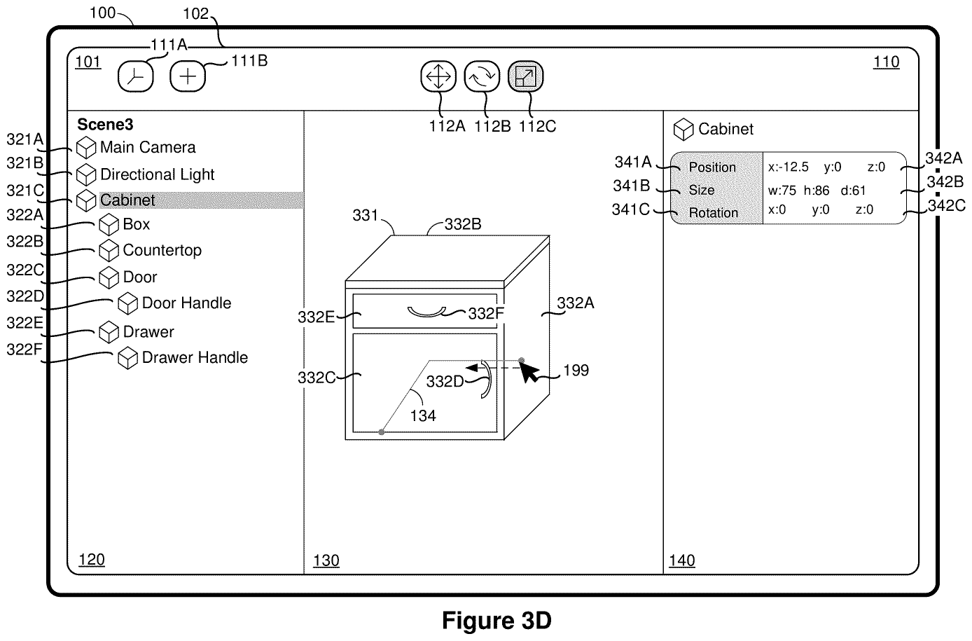

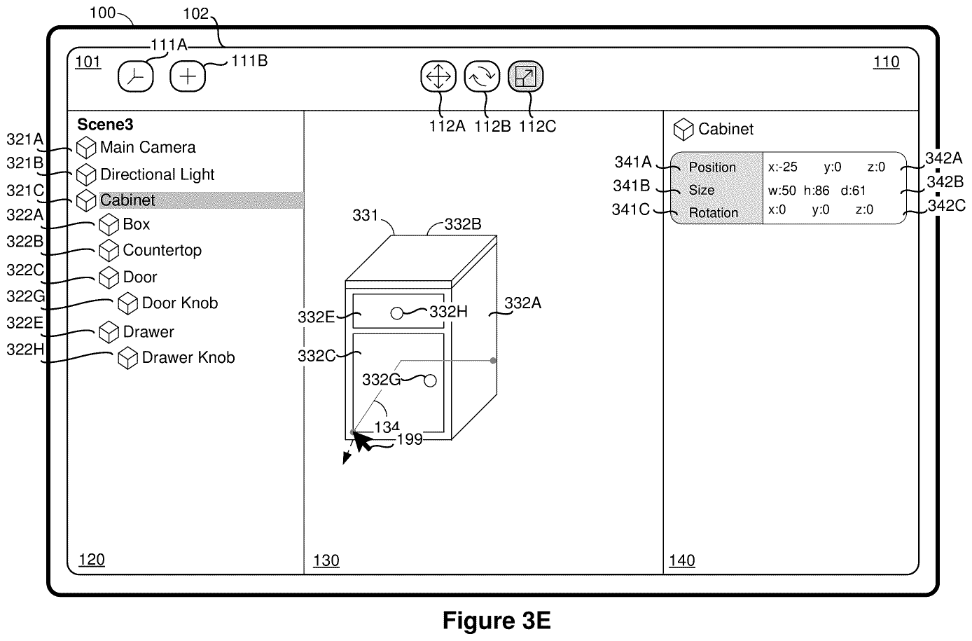

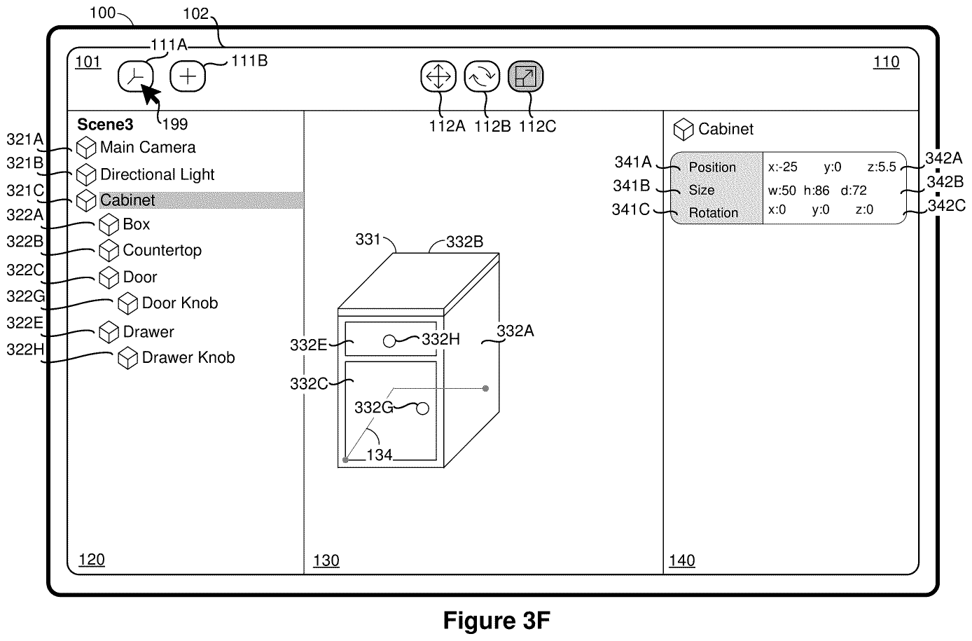

FIGS. 3A-3F illustrate the electronic device 100 displaying the scene composing user interface 101 of FIGS. 1A-1I with a third scene opened during a series of time periods. For ease of explanation, the numbering of time periods will be reset with the change from FIGS. 2A-2I to FIGS. 3A-3F.

FIG. 3A illustrates the electronic device 100 during a first time period. In FIG. 3A, the hierarchy region 120 includes a textual representation of a main camera object of the third scene 321A and a textual representation of a directional light object of the third scene 321B. In FIG. 3A, the preview region 130 is blank as there are no visible objects of the third scene. In FIG. 3A, the inspector region 140 is blank as there is no object selected. During the first time period, the cursor 199 is displayed over the add object affordance 111B within the toolbar region 110.

FIG. 3B illustrates the electronic device 100 during a second time period subsequent to the first time period. Between the first time period and the second time period, the add object affordance 111B has been selected to add a cabinet object to the scene. Thus, during the second time period, the hierarchy region 120 includes a textual representation of the cabinet object 321C. Further, during the second time period, the preview region 130 includes a graphical representation of the cabinet object 331. The textual representation of the cabinet object 321C is displayed in a different manner than the textual representations of the other objects to indicate that the cabinet object is selected. For example, in FIG. 3B, the textual representation of the cabinet object 321C is displayed with a gray background rather than a white background. Further, the graphical representation of the cabinet object 331 is displayed with a manipulator to indicate that the cabinet object is selected. In particular, because the manipulation mode of the scene composing user interface 101 is set to the position manipulation mode, the graphical representation of the cabinet object 331 is displayed with a position manipulator 132 to indicate that the cabinet object is selected. The position manipulation affordance 112A is displayed in a different manner than the other manipulation affordances to indicate that the scene composing user interface 101 is set to the position manipulation mode. In particular, in FIG. 3B, the position manipulation affordance 112A is displayed with a gray background rather than a white background.

Because the cabinet object is selected, the inspector region 140 includes indications of properties of the cabinet object and indications of values of those properties. For example, in FIG. 3B, the inspector region 140 includes an indication of a position property of the cabinet object 341A, an indication of a size property of the cabinet object 341B, and an indication of a rotation property of the cabinet object 341C. In respective association, the inspector region 140 includes an indication of the value of the position property of the cabinet object 342A, an indication of the value of the size property of the cabinet object 342B, and an indication of the value of the rotation property of the cabinet object 342C.

During the second time period, the value of the position property of the cabinet object (as indicated by the indication of the value of the position property of the cabinet object 342A) is “x:0 y:0 z:0” indicating that the cabinet object is centered at the origin of a three-dimensional coordinate system of the third scene. During the second time period, the value of the size property of the cabinet object (as indicated by the indication of the value of the size property of the cabinet object 342B) is “w:100 h:86 d:61” indicating that the cabinet object has a width of 100, a height of 86 units, and a depth of 61 units. During the second time period, the value of the rotation property of the cabinet object (as indicated by the indication of the value of the rotation property of the cabinet object 342C) is “x:0 y:0 z:0” indicating that the cabinet object is not rotated with respect to any of the axes of the three-dimensional coordinate system of the third scene.

The cabinet object is the parent object of a number of child objects, including a box object, a countertop object, a door object, and a drawer object. In turn, the door object has a door handle object as a child object and the drawer object has a drawer handle object and a child object. Accordingly, the hierarchy region 120 includes a textual representation of the box object 322A, a textual representation of the countertop object 322B, a textual representation of the door object 322C, and a textual representation of the drawer object 322E, each in association with the textual representation of the cabinet object 321C and indicating (e.g., via indentation) that the corresponding object is child object of the cabinet object. Further, the hierarchy region 120 includes a textual representation of the door handle object 322D in association with the textual representation of the door object 322C and indicating (e.g., via indentation) that the door handle object is a child object of the door object. Similarly, the hierarchy region 120 includes a textual representation of the drawer handle object 322F in association with the textual representation of the drawer object 322E and indicating (e.g., via indentation) that the drawer handle object is a child object of the drawer object.

Further, the graphical representation of the cabinet object 331 includes a graphical representation of the box object 332A, a graphical representation of the countertop object 332B, a graphical representation of the door object 332C, a graphical representation of the door handle object 332D, a graphical representation of the drawer object 332E, and a graphical representation of the drawer handle object 332F. In various implementations, the cabinet object is an empty object. Thus, the graphical representation of the cabinet object 331 is the aggregate of the graphical representations of the child objects (and child objects of those child objects). Each of the child objects of the cabinet object is associated with a size and a position in a three-dimensional coordinate system of the cabinet object that is related to the three-dimensional coordinate system of the third scene via a transform. Similarly, the door handle object is associated with a size and a position in a three-dimensional coordinate system of the door object that is related to the three-dimensional coordinate system of the cabinet object via a transform and the drawer handle object is associate with a size and a position in a three-dimensional coordinate system of the drawer object that is related to the three-dimensional coordinate system of the cabinet object via a transform. During the second time period, the cursor 199 is displayed over the size manipulation affordance 112C.

FIG. 3C illustrates the electronic device 100 during a third time period subsequent to the second time period. Between the second time period and the third time period, the size manipulation affordance 112C has been selected to set the manipulation mode of the scene composing user interface 101 to the size manipulation mode. Thus, in FIG. 3C, the size manipulation affordance 112C is displayed with a gray background (and the position manipulation affordance 112A has reverted to a white background). Further, the position manipulator 132 is replaced with the size manipulator 134.

In various implementations, the construction plan for the cabinet object indicates allowable sizes for the cabinet object. In particular, the construction plan for the cabinet object indicates a single allowable height, e.g., 86 units. Thus, as illustrated in FIG. 3C, in various implementations the size manipulator 134 does not include a height line for changing the height of the cabinet object. During the third time period, the cursor 199 is displayed over the width line of the size manipulator 134.

FIG. 3D illustrates the electronic device 100 during a fourth time period subsequent to the third time period. Between the third time period and the fourth time period, the cursor 199 has interacted with the width line of the size manipulator 134 to change the width of the cabinet object. Thus, during the fourth time period as compared to the third time period, the graphical representation of the cabinet object 331 is narrower. Further, during the fourth time period, the value of the size property of the cabinet object (as indicated by the indication of the value of the size property of the cabinet object 342B) is changed to “w:75 h:86 d:61” indicating that that the cabinet object is 25 units narrower in the three-dimensional coordinate system of the cabinet object. In various implementations, when the size of an object is changed, both sides of the object change position and the center remains stationary. In various implementations, when the size of an object is changed, one side of the object changes position and the center moves in the direction of the size increase or decrease. Thus, during the fourth time period, the value of the position property of the cabinet object (as indicated by the indication of the value of the position property of the cabinet object 342A) is changed to “x:−12.5 y:0 z:0” indicating that the center of the cabinet object has moved to the left 12.5 units (half of the change in width).

In the absence of a construction plan, when the width of the cabinet object decreases by 25 percent, each of the child objects similarly decreases in width by 25 percent. However, due the construction plan for the cabinet object, this does not occur. Rather, in response to the width of the cabinet object decreasing by 25 percent, the box object and the countertop object decrease in width by 25 percent, but the door object and the drawer object decrease in width by more than 25 percent in order to maintain a constant distance between the edges of the door object and drawer object and the corresponding edges of the box object.

In the absence of a construction plan, when the width of the door object and the drawer object decreases, the door handle object and drawer handle object similarly decrease in width. However, due to the construction plan for the cabinet object, this does not occur and the door handle object and drawer handle object maintain their size.

Thus, during the fourth time period as compared to the third time period, the graphical representation of the box object 332A and the graphical representation of the countertop object 332B is 25 percent narrower; the graphical representation of the door object 332C and the graphical representation of the drawer object 332E is more than 25 percent narrower; and the graphical representation of the door handle object 332D and the graphical representation of the drawer handle object 332F maintain their size. During the fourth time period, the cursor 199 is displayed over the width line of the size manipulator 134.

FIG. 3E illustrates the electronic device 100 during a fifth time period subsequent to the fourth time period. Between the fourth time period and the fifth time period, the cursor 199 has interacted with the width line of the size manipulator 134 to change the width of the cabinet object. Thus, during the fifth time period as compared to the fourth time period, the graphical representation of the cabinet object 331 is narrower. Further, during the fifth time period, the value of the size property of the cabinet object (as indicated by the indication of the value of the size property of the cabinet object 342B) is changed to “w:50 h:86 d:61” indicating that that the cabinet object is 25 units narrower in the three-dimensional coordinate system of the cabinet object. In various implementations, when the size of an object is changed, both sides of the object change position and the center remains stationary. In various implementations, when the size of an object is changed, one side of the object changes position and the center moves in the direction of the size increase or decrease. Thus, during the fifth time period, the value of the position property of the cabinet object (as indicated by the indication of the value of the position property of the cabinet object 342A) is changed to “x:−25 y:0 z:0” indicating that the center of the cabinet object has moved to the left 12.5 units (half of the change in width).

In the absence of a construction plan, when the width of the cabinet object decreases by 33 percent, each of the child objects similarly decreases in width by 33 percent. However, due the construction plan for the cabinet object, this does not occur. Rather, in response to the width of the couch object decreasing by 33 percent, the box object and the countertop object decrease in width by 33 percent, but the door object and the drawer object decrease in width by more than 33 percent to maintain a constant distance between the edges of the door object and drawer object and the corresponding edges of the box object.

In the absence of a construction plan, when the width of the door object and the drawer object decreases, the door handle object and drawer handle object similarly decrease in width. However, due to the construction plan for the cabinet object, this does not occur. Rather, when the width of the door object and the drawer object is below a threshold, the door handle object and the drawer handle object are replaced with a door knob object and a drawer knob object. Accordingly, the hierarchy region 120 includes a textual representation of the door know object 322G and a textual representation of the drawer knob object 322H and the preview region 130 includes a graphical representation of the door knob object 332G and a graphical representation of the of the drawer knob object 332H.

Thus, during the fifth time period as compared to the fourth time period, the graphical representation of the box object 332A and the graphical representation of the countertop object 332B are 33 percent narrower; the graphical representation of the door object 332C and the graphical representation of the drawer object 332E are more than 33 percent narrower; and the graphical representation of the door handle object 332D and the graphical representation of the drawer handle object 332F are replaced with the graphical representation of the door knob object 332G and the graphical representation of the drawer knob object 332H. During the fifth time period, the cursor 199 is displayed over the depth line of the size manipulator 134.

Whereas the construction plan for the cabinet object specifies a single allowable height, the construction plan for the cabinet object specifies two allowable depths, and a range of allowable widths from a minimum width to a maximum width. By interacting with the depth line of the size manipulator 134, the depth of the cabinet object can be changed between the two allowable depths.

FIG. 3F illustrates the electronic device 100 during a sixth time period subsequent to the fifth time period. Between the fifth time period and the sixth time period, the cursor 199 has interacted with the depth line of the size manipulator 134 to change the depth of the cabinet object. Thus, during the sixth time period as compared to the fifth time period, the graphical representation of the cabinet object 331 is deeper. Further, during the sixth time period, the value of the size property of the cabinet object (as indicated by the indication of the value of the size property of the cabinet object 342B) is changed to “w:50 h:86 d:72” indicating that the cabinet object is 11 units deeper in the three-dimensional coordinate system of the cabinet object. In various implementations, when the size of an object is changed, both sides of the object change position and the center remains stationary. In various implementations, when the size of an object is changed, one side of the object changes position and the center moves in the direction of the size increase or decrease. Thus, during the sixth time period, the value of the position property of the cabinet object (as indicated by the indication of the value of the position property of the cabinet object 342A) is changed to “x:−25 y:0 z:5.5” indicating that the center of the cabinet object has moved forward 5.5 units (half of the change in depth).

In the absence of a construction plan, when the depth of the cabinet object increases by 18 percent, each of the child objects similarly increases in depth by 18 percent. However, due the construction plan for the cabinet object, this does not occur. Rather, in response to the depth of the cabinet object increasing by 18 percent, the box object and the countertop object increase in depth by 18 percent, the drawer object increases in depth by more than 18 percent, and the size of the door object does not change.

During the sixth time period as compared to the fifth time period, the graphical representation of the box object 332A and the graphical representation of the countertop object 332B is 18 percent deeper; the graphical representation of the drawer object 332E is more than 18 percent deeper; and the graphical representation of the door object 332C is unchanged. During the sixth time period, the cursor 199 is displayed over the new scene affordance 111A.

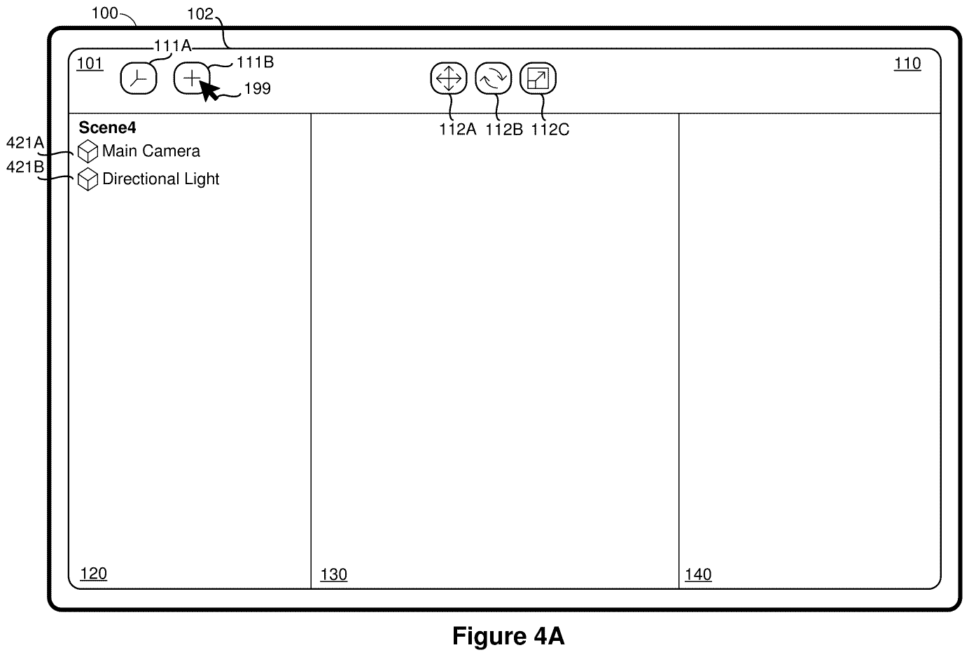

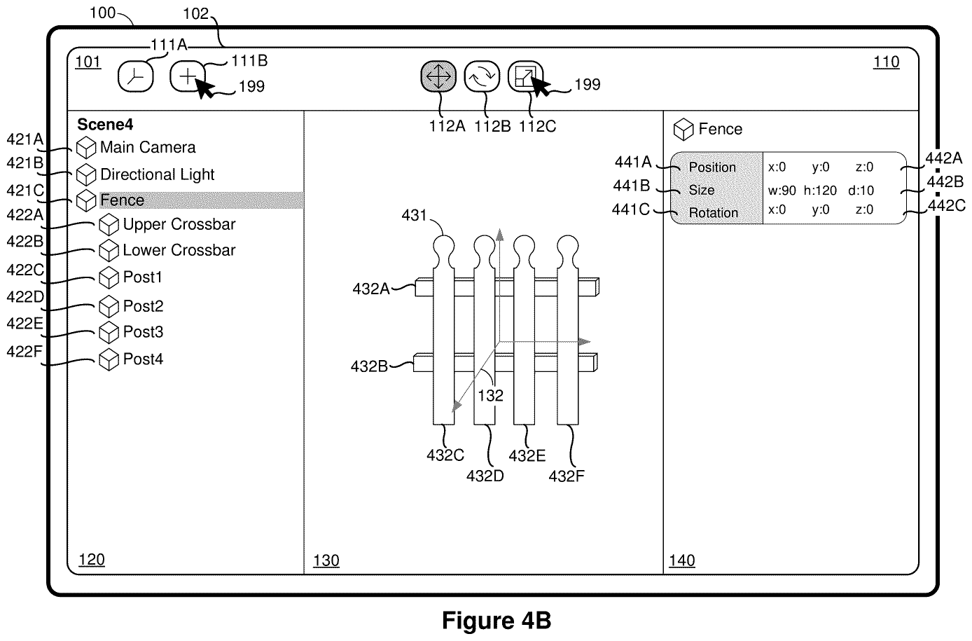

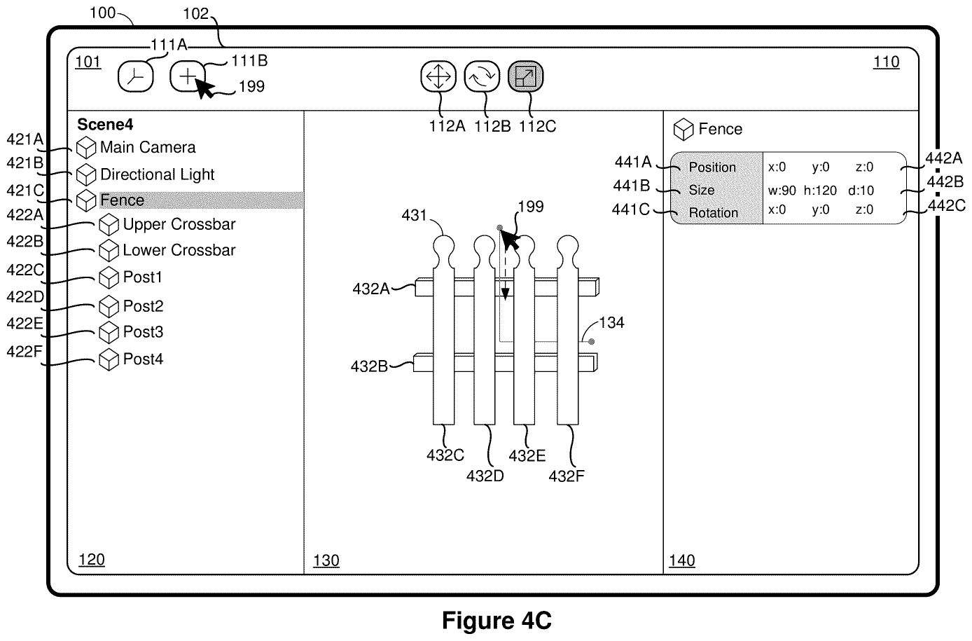

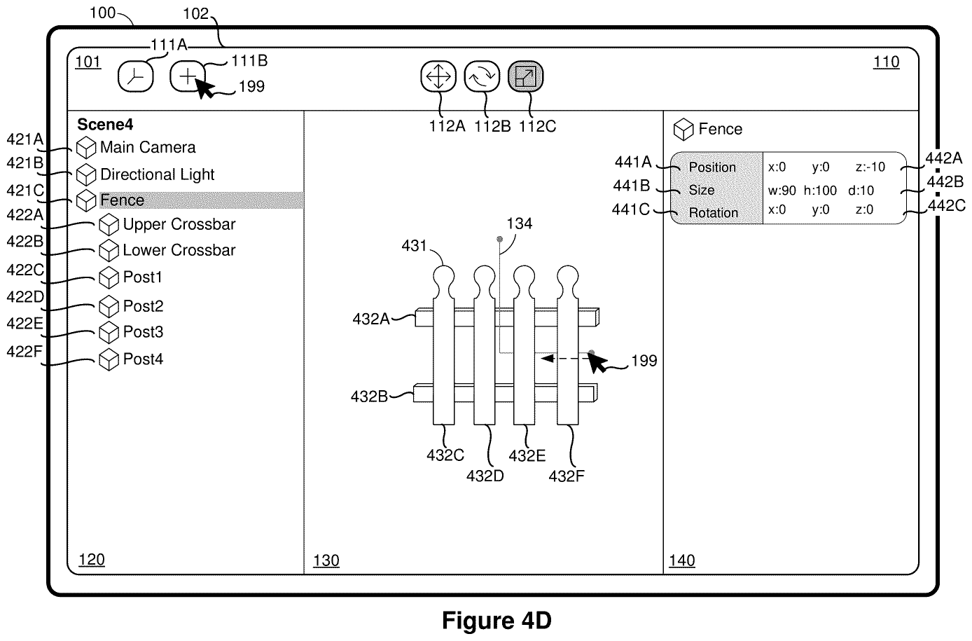

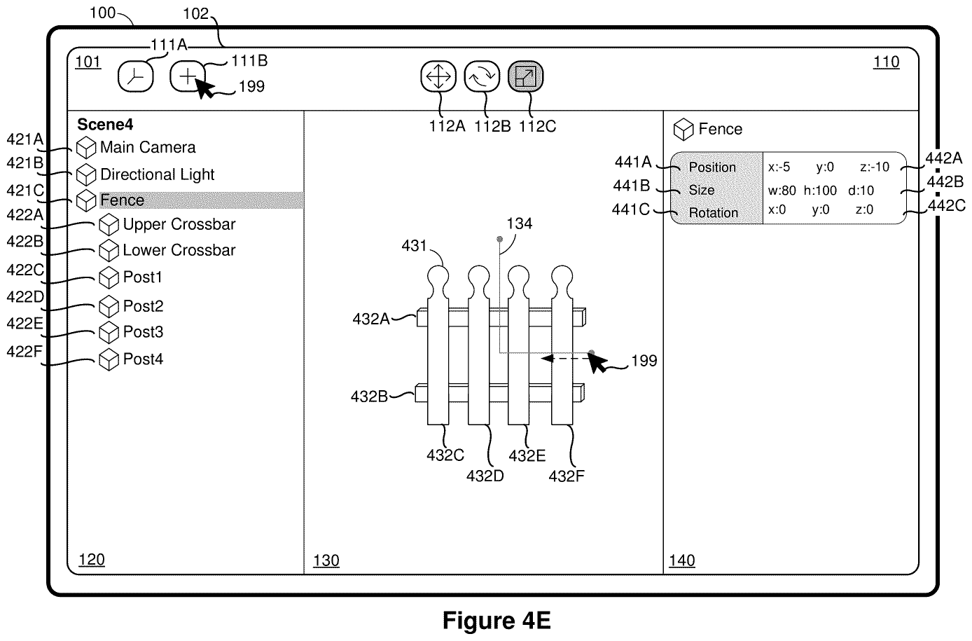

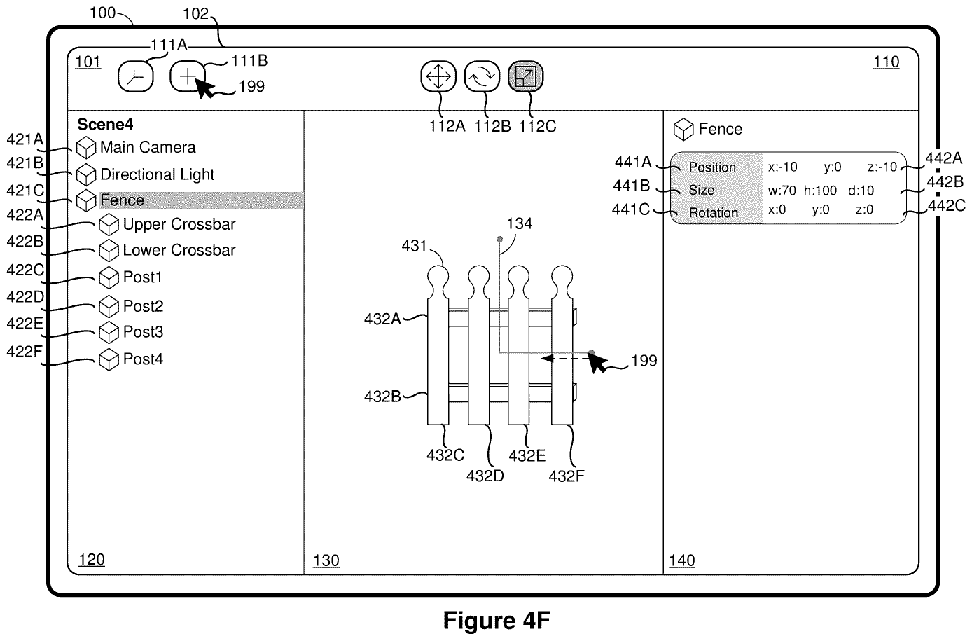

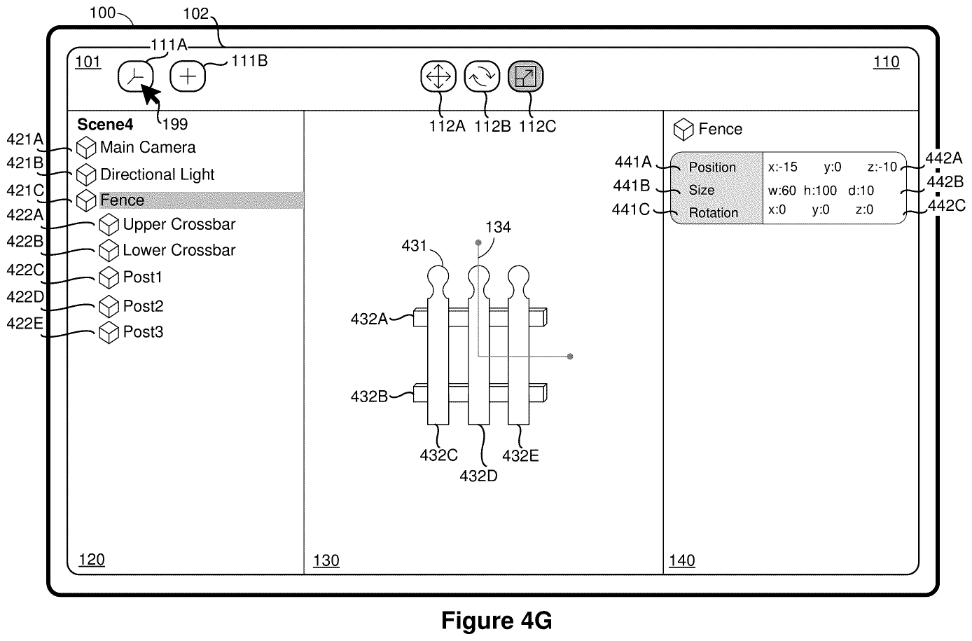

FIGS. 4A-4G illustrate the electronic device 100 displaying the scene composing user interface 101 of FIGS. 1A-1I with a fourth scene opened during a series of time periods. For ease of explanation, the numbering of time periods will be reset with the change from FIGS. 3A-3F to FIGS. 4A-4G.

FIG. 4A illustrates the electronic device 100 during a first time period. In FIG. 4A, the hierarchy region 120 includes a textual representation of a main camera object of the fourth scene 421A and a textual representation of a directional light object of the fourth scene 421B. In FIG. 4A, the preview region 130 is blank as there are no visible objects of the fourth scene. In FIG. 4A, the inspector region 140 is blank as there is no object selected. During the first time period, the cursor 199 is displayed over the add object affordance 111B within the toolbar region 110.

FIG. 4B illustrates the electronic device 100 during a second time period subsequent to the first time period. Between the first time period and the second time period, the add object affordance 111B has been selected to add a fence object to the scene. Thus, during the second time period, the hierarchy region 120 includes a textual representation of the fence object 421C. Further, during the second time period, the preview region 130 includes a graphical representation of the fence object 431. The textual representation of the fence object 421C is displayed in a different manner than the textual representations of the other objects to indicate that the fence object is selected. For example, in FIG. 4B, the textual representation of the fence object 421C is displayed with a gray background rather than a white background. Further, the graphical representation of the fence object 431 is displayed with a manipulator to indicate that the fence object is selected. In particular, because the manipulation mode of the scene composing user interface 101 is set to the position manipulation mode, the graphical representation of the fence object 431 is displayed with the position manipulator 132 to indicate that the fence object is selected. The position manipulation affordance 112A is displayed in a different manner than the other manipulation affordances to indicate that the scene composing user interface 101 is set to the position manipulation mode. In particular, in FIG. 4B, the position manipulation affordance 112A is displayed with a gray background rather than a white background.

Because the fence object is selected, the inspector region 140 includes indications of properties of the fence object and indications of values of those properties. For example, in FIG. 4B, the inspector region 140 includes an indication of a position property of the fence object 441A, an indication of a size property of the fence object 441B, and an indication of a rotation property of the fence object 441C. In respective association, the inspector region 140 includes an indication of the value of the position property of the fence object 442A, an indication of the value of the size property of the fence object 442B, and an indication of the value of the rotation property of the fence object 442C.

During the second time period, the value of the position property of the fence object (as indicated by the indication of the value of the position property of the fence object 442A) is “x:0 y:0 z:0” indicating that the fence object is centered at the origin of a three-dimensional coordinate system of the fourth scene. During the second time period, the value of the size property of the fence object (as indicated by the indication of the value of the size property of the fence object 442B) is “w:90 h:120 d:10” indicating that the fence object has a width of 90 units, a height of 120 units, and a depth of 10 units. During the second time period, the value of the rotation property of the fence object (as indicated by the indication of the value of the rotation property of the fence object 442C) is “x:0 y:0 z:0” indicating that the fence object is not rotated with respect to any of the axes of the three-dimensional coordinate system of the fourth scene.

The fence object is the parent object of a number of child objects, including an upper crossbar object, a lower crossbar object, a first post object, a second post object, a third post object, and a fourth post object. Accordingly, the hierarchy region 120 includes a textual representation of the upper crossbar object 422A, a textual representation of the lower crossbar object 422B, a textual representation of the first post object 422C, a textual representation of the second post object 422D, a textual representation of the third post object 422E, and a textual representation of the fourth post object 422F, each in association with the textual representation of the fence object 421C and indicating (e.g., via indentation) that the corresponding object is child object of the fence object.

Further, the graphical representation of the fence object 431 includes a graphical representation of the upper crossbar object 432A, a graphical representation of the lower crossbar object 432B, a graphical representation of the first post object 432C, a graphical representation of the second post object 432D, a graphical representation of the third post object 432E, and a graphical representation of the fourth post object 432F. In various implementations, the fence object is an empty object. Thus, the graphical representation of the fence object 431 is the aggregate of the graphical representations of the child objects. Each of the child objects of the fence object is associated with a size and a position in a three-dimensional coordinate system of the fence object that is related to the three-dimensional coordinate system of the fourth scene via a transform. During the second time period, the cursor 199 is displayed over the size manipulation affordance 112C.

FIG. 4C illustrates the electronic device 100 during a third time period subsequent to the second time period. Between the second time period and the third time period, the size manipulation affordance 112C has been selected to set the manipulation mode of the scene composing user interface 101 to the size manipulation mode. Thus, in FIG. 4C, the size manipulation affordance 112C is displayed with a gray background (and the position manipulation affordance 112A has reverted to a white background). Further, the position manipulator 132 is replaced with the size manipulator 134.

In various implementations, the construction plan indicates allowable sizes for the fence object. In particular, the construction plan for the fence object indicates a single allowable depth, e.g., 10 units. Thus, as illustrated in FIG. 4C, in various implementations the size manipulator 134 does not include a depth line for changing the depth of the fence object. During the third time period, the cursor 199 is located over the width line of the size manipulator 134.

FIG. 4D illustrates the electronic device 100 during a fourth time period subsequent to the third time period. Between the third time period and the fourth time period, the cursor 199 has interacted with the height line of the size manipulator 134 to change the height of the fence object. Thus, during the fourth time period as compared to the third time period, the graphical representation of the fence object 431 is shorter. Further, during the fourth time period, the value of the size property of the fence object (as indicated by the indication of the value of the size property of the fence object 442B) is changed to “w:90 h:100 d:10” indicating that that the fence object is 20 units shorter in the three-dimensional coordinate system of the fence object. In various implementations, when the size of an object is changed, both sides of the object change position and the center remains stationary. In various implementations, when the size of an object is changed, one side of the object changes position and the center moves in the direction of the size increase or decrease. Thus, during the fourth time period, the value of the position property of the fence object (as indicated by the indication of the value of the position property of the fence object 442A) is changed to “x:0 y:0 z:−10” indicating that the center of the fence object has moved to down 10 units (half of the change in height).

In the absence of a construction plan, when the height of the fence object decreases by 17 percent, each of the child objects similarly decreases in height by 17 percent. However, due the construction plan for the fence object, this does not occur. Rather, in response to the height of the fence object decreasing by 17 percent, the post objects decrease in height by 17 percent, but the crossbar objects do not decrease in height.

Further, in various implementations, when the post objects decrease in height, the bodies, but not the heads, of the post objects decrease in height. In various implementations, this is effectuated by having the bodies and heads be child objects of the respective post objects. In various implementations, this is effectuated by having a size-dependent mesh.

In the absence of a construction plan, when the height of the fence object decreases by 17 percent, the position in the corresponding dimension of the three-dimensional coordinate system of the fence object of each child object similarly decreases by 17 percent. However, due the construction plan for the fence object, this does not occur. In particular, the construction plan for the fence object maintains the distance from the top of the post objects to the top of the upper crossbar object and maintains the distance between the crossbar objects. Thus, decreasing the height of the fence object simulates sawing the bottoms of the post objects.

During the fourth time period as compared to the third time period, the graphical representation of the upper crossbar object 432A and the graphical representation of the lower crossbar object 432B are unchanged in height, but moved (e.g., lowered) in the corresponding dimension of the three-dimensional coordinate system of the fence object such that the distance between the top of the post objects and the upper crossbar object is unchanged and the distance between the upper crossbar object and the lower crossbar object is unchanged. Further, during the fourth time period as compared to the third time period, the graphical representation of the first post object 432C, the graphical representation of the second post object 432D, the graphical representation of the third post object 432E, and the graphical representation of the fourth post object 432F are 17 percent shorter, but unmoved in the corresponding dimension of the three-dimensional coordinate system of the fence object. During the fourth time period, the cursor 199 is displayed over the width line of the size manipulator 134.

FIG. 4E illustrates the electronic device 100 during a fifth time period subsequent to the fourth time period. Between the fourth time period and the fifth time period, the cursor 199 has interacted with the width line of the size manipulator 134 to change the width of the fence object. Thus, during the fifth time period as compared to the fourth time period, the graphical representation of the fence object 431 is narrower. Further, during the fifth time period, the value of the size property of the fence object (as indicated by the indication of the value of the size property of the fence object 442B) is changed to “w:80 h:100 d:10” indicating that that the fence object is 10 units narrower in the three-dimensional coordinate system of the fence object. In various implementations, when the size of an object is changed, both sides of the object change position and the center remains stationary. In various implementations, when the size of an object is changed, one side of the object changes position and the center moves in the direction of the size increase or decrease. Thus, during the fifth time period, the value of the position property of the fence object (as indicated by the indication of the value of the position property of the fence object 442A) is changed to “x:−5 y:0 z:−10” indicating that the center of the fence object has moved left 5 units (half of the change in width).

In the absence of a construction plan, when the width of the fence object decreases by 11 percent, each of the child objects similarly decreases in width by 11 percent. However, due the construction plan for the fence object, this does not occur. Rather, in response to the width of the fence object decreasing by 11 percent, the crossbar objects decrease in width by 17 percent, but the post objects do not decrease in width.

In the absence of a construction plan, when the width of the fence object decreases by 11 percent, the position in the corresponding dimension of the three-dimensional coordinate system of the fence object of each child object similarly decreases by 11 percent. However, due the construction plan for the fence object, this does not occur. In particular, the construction plan for the fence object maintains the distances between post objects. Thus, decreasing the width of the fence object simulates sawing off the sides of the crossbar objects.

During the fifth time period as compared to the fourth time period, the graphical representation of the upper crossbar object 432A and the graphical representation of the lower crossbar object 432B are 11 percent narrower, but unmoved in the corresponding dimension of the three-dimensional coordinate system of the fence object. Further, during the fifth time period as compared to the fourth time period, the graphical representation of the first post object 432C, the graphical representation of the second post object 432D, the graphical representation of the third post object 432E, and the graphical representation of the fourth post object 432F are unchanged in width and unmoved in the corresponding dimension of the three-dimensional coordinate system of the fence object. During the fifth time period, the cursor 199 is displayed over the width line of the size manipulator 134.

FIG. 4F illustrates the electronic device 100 during a sixth time period subsequent to the fifth time period. Between the fifth time period and the sixth time period, the cursor 199 has interacted with the width line of the size manipulator 134 to change the width of the fence object. Thus, during the sixth time period as compared to the fifth time period, the graphical representation of the fence object 431 is narrower. Further, during the sixth time period, the value of the size property of the fence object (as indicated by the indication of the value of the size property of the fence object 442B) is changed to “w:70 h:100 d:10” indicating that that the fence object is 10 units narrower in the three-dimensional coordinate system of the fence object. In various implementations, when the size of an object is changed, both sides of the object change position and the center remains stationary. In various implementations, when the size of an object is changed, one side of the object changes position and the center moves in the direction of the size increase or decrease. Thus, during the sixth time period, the value of the position property of the fence object (as indicated by the indication of the value of the position property of the fence object 442A) is changed to “x:−10 y:0 z:−10” indicating that the center of the fence object has moved left 5 units (half of the change in width).

In the absence of a construction plan, when the width of the fence object decreases by 13 percent, each of the child objects similarly decreases in width by 13 percent. However, due the construction plan for the fence object, this does not occur. Rather, in response to the width of the fence object decreasing by 13 percent, the crossbar objects decrease in width by 13 percent, but the post objects do not decrease in width.

In the absence of a construction plan, when the width of the fence object decreases by 13 percent, the position in the corresponding dimension of the three-dimensional coordinate system of the fence object of each child object similarly decreases by 13 percent. However, due the construction plan for the fence object, this does not occur. As noted above, the construction plan for the fence object maintains the distances between post objects. Thus, decreasing the width of the fence object simulates sawing off the sides of the crossbar objects.

During the sixth time period as compared to the fifth time period, the graphical representation of the upper crossbar object 432A and the graphical representation of the lower crossbar object 432B are 13 percent narrower, but unmoved in the corresponding dimension of the three-dimensional coordinate system of the fence object. Further, during the sixth time period as compared to the fifth time period, the graphical representation of the first post object 432C, the graphical representation of the second post object 432D, the graphical representation of the third post object 432E, and the graphical representation of the fourth post object 432F are unchanged in width and unmoved in the corresponding dimension of the three-dimensional coordinate system of the fence object. During the sixth time period, the cursor 199 is displayed over the width line of the size manipulator 134.

FIG. 4G illustrates the electronic device 100 during a seventh time period subsequent to the sixth time period. Between the sixth time period and the seventh time period, the cursor 199 has interacted with the width line of the size manipulator 134 to change the width of the fence object. Thus, during the seventh time period as compared to the sixth time period, the graphical representation of the fence object 431 is narrower. Further, during the sixth time period, the value of the size property of the fence object (as indicated by the indication of the value of the size property of the fence object 442B) is changed to “w:60 h:100 d:10” indicating that that the fence object is 10 units narrower in the three-dimensional coordinate system of the fence object. In various implementations, when the size of an object is changed, both sides of the object change position and the center remains stationary. In various implementations, when the size of an object is changed, one side of the object changes position and the center moves in the direction of the size increase or decrease. Thus, during the sixth time period, the value of the position property of the fence object (as indicated by the indication of the value of the position property of the fence object 442A) is changed to “x:−15 y:0 z:−10” indicating that the center of the fence object has moved left 5 units (half of the change in width).

In the absence of a construction plan, when the width of the fence object decreases by 14 percent, each of the child objects similarly decreases in width by 14 percent. However, due the construction plan for the fence object, this does not occur. Rather, in response to the width of the fence object decreasing by 14 percent, the crossbar objects decrease in width by 14 percent, but the post objects do not decrease in width. However, to maintain the distance between the post objects and ensure that the post objects maintain contact with the crossbar objects, the fourth post object is removed and the other post objects moved to be (in aggregate) centered with the crossbar objects.

In the absence of a construction plan, when the width of the fence object decreases by 14 percent, the position in the corresponding dimension of the three-dimensional coordinate system of the fence object of each child object similarly decreases by 14 percent. However, due the construction plan for the fence object, this does not occur. As noted above, the construction plan for the fence object maintains the distances between post objects and the centers the group of post objects on the crossbar objects. With the removal of the fourth post object, the other post objects are moved to the right in the corresponding dimension of the three-dimensional coordinate system of the fence object to center the first post object, second post object, and third post object on the crossbar objects.

During the seventh time period as compared to the sixth time period, the graphical representation of the upper crossbar object 432A and the graphical representation of the lower crossbar object 432B are 14 percent narrower, but unmoved in the corresponding dimension of the three-dimensional coordinate system of the fence object. Further, during the seventh time period as compared to the sixth time period, the graphical representation of the first post object 432C, the graphical representation of the second post object 432D, the graphical representation of the third post object 432E are unchanged in width, but moved in the corresponding dimension of the three-dimensional coordinate system of the fence object to center the post objects on the crossbar objects. Further, during the seventh time period as compared to the sixth time period, the graphical representation of the fourth post object 432F is absent (as is the textual representation of the fourth post object 422F). During the sixth time period, the cursor 199 is displayed over the new scene affordance 111A.

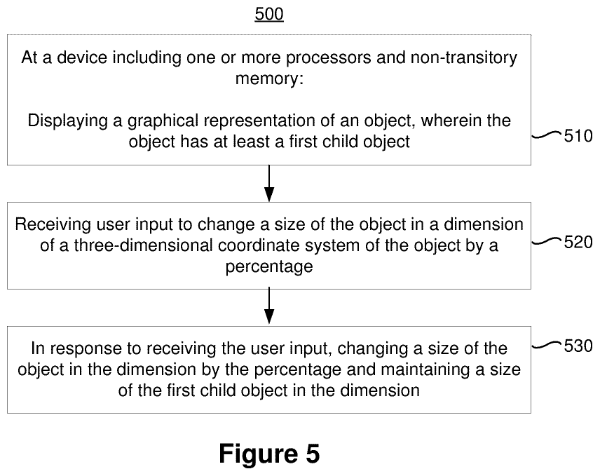

FIG. 5 is a flowchart representation of a method 500 of resizing an object in accordance with some implementations. In various implementations, the method 500 is performed by an electronic device. In various implementations, the method 500 is performed by a device one or more processors and non-transitory memory. In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begin, in block 510, with the device displaying a graphical representation of an object, wherein the object has at least a first child object. For example, in FIG. 2B, the electronic device 100 displays the graphical representation of couch object 231. As another example, in FIG. 3B, the electronic device 100 displays the graphical representation of the cabinet object 331. As another example, in FIG. 4B, the electronic device 100 displays the graphical representation of the fence object 431. In various implementations, the object is an empty object and the graphical representation of the object is an aggregate of graphical representations of child objects of the object, including at least the first child object.

In various implementations, displaying the graphical representation of the object includes displaying a scene composing user interface including a graphical representation of the object. In various implementations, the scene composing user interface further includes a textual representation of the object. In various implementations, the scene composing user interface further includes indications of properties of the object and indications of the values of those properties.

The method 500 continues, in block 520, with the device receiving user input to change a size of the object in a dimension of a three-dimensional coordinate system of the object by a percentage. For example, between the time periods of FIG. 2D and FIG. 2E, the cursor 199 interacts with the width line of the size manipulator 134 to increase the width of the couch object by 25 percent. As another example, between the time periods of FIG. 3E and FIG. 3F, the cursor 199 interacts with the depth line of the size manipulator 134 to increase the depth of the cabinet object by 18 percent. As another example, between the time periods of FIG. 4C and FIG. 4D, the cursor 199 interacts with the height line of the size manipulator 134 to decrease the height of the fence by 20 percent.

In various implementations, the user input to change the size of the object does not explicitly specify the percentage. For example, referring to FIG. 2B, in various implementations, a user can change the size of the couch object by selecting the indication of the value of the size of the couch object 242B and typing (using a keyboard) a new value for, e.g., the depth of the couch object. Thus, whereas the user specifies the depth in units, the user input indicates a percentage change in the depth. For example, referring still to FIG. 2B, if a user were to enter a new depth of 130 units, this would be a user input to increase the depth of the object by 30 percent.

The method 500 continues, in block 530, with the device, in response to receiving the user input, changing the size of the object in the dimension by the percentage and maintaining a size of the first child object in the dimension. For example, in FIG. 2E, in response to a user input to increase the width of the couch object by 25 percent (e.g., from 200 units to 250 units), the electronic device 100 increases the width of the couch object by 25 percent while maintaining the width of the left arm object and the right arm object. As another example, in FIG. 2G, in response to a user input to increase the depth of the couch object by 40 percent (e.g., from 100 units to 140 units), the electronic device 100 increases the depth of the couch object by 40 percent while maintaining the depth of the back object. As another example, in FIG. 3F, in response to a user input to increase the depth of the cabinet object by 18 percent (e.g., from 61 units to 72 units), the electronic device 100 increases the depth of the cabinet object by 18 percent while maintaining the depth of the door object. As another example, in FIG. 4D, in response to a user input to decrease the height of the fence object by 17 percent (e.g., from 120 units to 100 units), the electronic device 100 decreases the height of the fence object by 17 percent while maintaining the height of the upper crossbar object and the height of the lower crossbar object.

In various implementations, the object has a second child object. In various implementations, the method 500 further comprises, in response to receiving the user input, changing a size of the second object in the dimension by the percentage. For example, in FIG. 2F, in response to a user input to increase the width of the couch object by 20 percent (e.g., from 250 units to 300 units), the electronic device 100 increases the width of the couch object by 20 percent, maintains the width of the left arm object and the width of the right arm object, and increases the width of the base object by 20 percent. As another example, in FIG. 4D, in response to a user input to decrease the height of the fence object by 17 percent (e.g., from 120 units to 100 units), the electronic device 100 decreases the height of the fence object by 17 percent, maintains the height of the crossbar objects, and decreases the height of the post objects by 17 percent.

In various implementations, the method 500 further comprises, in response to receiving the user input, changing a size of the second object in the dimension by more than the percentage. For example, in FIG. 2E, in response to a user input to increase the width of the couch object by 25 percent (e.g., from 200 units to 250 units), the electronic device 100 increases the width of the couch object by 25 percent, maintains the width of the left arm object and the width of the right arm object, and increases the width of the left cushion object and the right cushion object by more than 25 percent. As another example, in FIG. 3D, in response to a user input to decrease the width of the cabinet object by 25 percent (e.g., from 100 units to 75 units), the electronic device 100 decreases the width of the box object, maintains the width of the door handle object, and decreases the width of the door object by more than 25 percent.

In various implementations, the method 500 further comprises, in response to receiving the user input, changing a size of the second object in the dimension by less than the percentage. For example, referring to FIG. 2F, in various implementations, in response to a user input to increase the width of the couch object by 20 percent (e.g., from 250 units to 300 units), rather than maintaining the width of the left arm object and width of the right arm object (as shown in FIG. 2F), the electronic device increases the width of the left arm object and the width of the right arm object by 10 percent (e.g., less than 20 percent).

In various implementations, the method 500 further comprises, in response to receiving the user input, changing a size of the second object in the dimension in a direction opposite the change in size of the object. For example, in FIG. 2F, in response to a user input to increase the width of the couch object by 20 percent (e.g., from 250 units to 300 units), the electronic device increases the width of the couch object by 20 percent, maintains the width of the left arm object and the right arm object, and decreases the width of the left cushion object and the right cushion object.

In various implementations, the method 500 further comprises, in response to receiving the user input, removing the second child object. For example, in FIG. 4G, in response to a user input to decrease the width of the fence object by 14 percent (e.g., from 70 units to 60 units), the electronic device 100 decreases the width of the fence object by 14 percent, maintains the width of the first post object, and removes the fourth post object. In various implementations, removing the second child object includes replacing the second child object with a third child object. For example, in FIG. 3E, in response to a user input to decrease the width of the cabinet object by 33 percent (e.g., from 75 units to 50 units), the electronic device 100 removes the drawer handle object and replaces it with the drawer knob object.

In various implementations, the method 500 further comprises, in response to receiving the user input, adding a second child object. For example, in FIG. 2F, in response to a user input to increase the width of the couch object by 20 percent (e.g., from 250 units to 300 units), the electronic device 100 adds the middle cushion object to the couch object. In various implementations, adding the second child object is performed in accordance with a determination that the size of the object in the dimension is greater than a first threshold. In various implementations, the method 500 further comprises removing the second child object in accordance with a determination that the size of the object in the dimension is less than a second threshold, which may be same or different than the first threshold.

In various implementations, the method 500 further comprises, in response to receiving the user input, maintaining a position of the first child object in the dimension. For example, in FIG. 4E, in response to a user input to decrease the width of the fence object by 11 percent, the electronic device 100 decreases the width of the fence object by 11 percent, maintains the width of the first post object, and maintains the position of the first post object in the corresponding dimension of the three-dimensional coordinate system of the fence object.

In various implementations, the method 500 further comprises, in response to receiving the user input, changing a position of the first child object by more than the percentage. For example, in FIG. 2E, in response to a user input to increase the width of the couch object by 25 percent (e.g., from 200 units to 250 units), the electronic device 100 moves the left cushion object and right cushion object more than 25 percent further from the origin of the three-dimensional coordinate system of the couch object. In various implementations, the method 500 comprises, in response to receiving the user input, changing a position of the first child object by the percentage or less than the percentage.

In various implementations, the method 500 further comprises receiving second user input to change a size of the object in a second dimension of the three-dimensional coordinate system of the object by a second percentage. The method 500 further comprises, in response to receiving the second user input, changing the size of the object in the second dimension by the second percentage and changing the size of the child object in the second dimension by at least the second percentage. For example, in FIG. 2E, in response to a user input to increase the width of the couch object by 25 percent (e.g., from 200 units to 250 units), the electronic device 100 increases the width of the couch object by 25 percent and maintains the width of the left arm object and the width of the right arm object. Later, in FIG. 2G, in response to a user input to increase the depth of the couch object by 40 percent (e.g., from 100 units to 140 units), the electronic device 100 increases the depth of the couch object by 40 percent and increases the depth of the left arm object and the depth of the right arm object by more than 40 percent.

In various implementations, the first user input and the second user input are received at different times (e.g., as in the example above). However, in various implementations, the first user input and the second user input are received simultaneously. For example, in various implementations, the size manipulator 134 manifests as a box around the selected object and interacting with the faces changes the size of one dimension, but interacting with the corners changes the sizes of two dimensions. As another example, referring to FIG. 2B, if a user interacts with the indication of the value of the size property of the couch object 242B, the user may enter more than one new size value.

In various implementations, the method 500 further comprises, storing a construction plan of the object, wherein maintaining the size of the first child object in the dimension is performed according to the construction plan. In various implementations, the method 500 further comprises changing a size of the second child object in the dimension according to the construction plan. In various implementations, the construction plan specifies the size of the second child object in the dimension for various sizes of the object in the dimension. In various implementations, the construction plan further specifies a position of the second child object in the dimension for the various sizes of the object in the dimension.

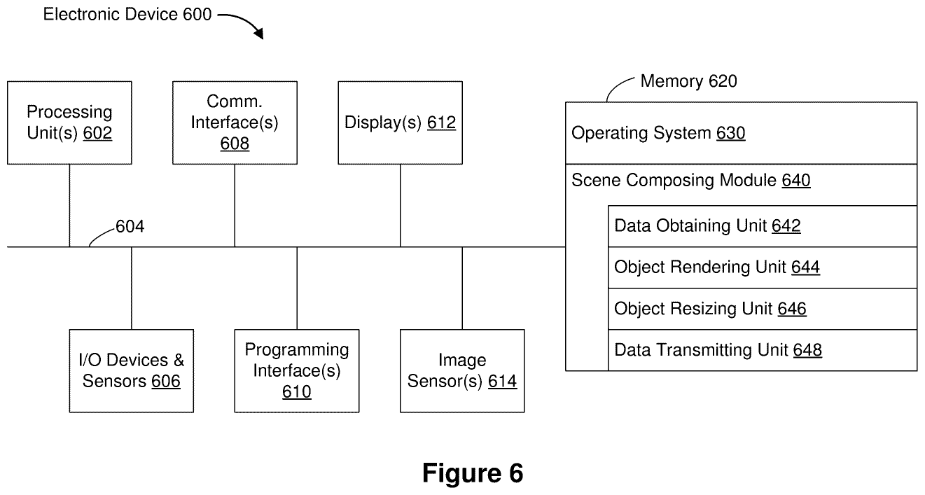

FIG. 6 is a block diagram of an example of an electronic device 600 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 600 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 610, one or more displays 612, one or more optional interior-and/or exterior-facing image sensors 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 612 are configured to display a virtual environment. In some implementations, the one or more displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 612 correspond to diffractive, reflective, polarized, holographic, etc. waveguide displays. In one example, the electronic device 600 includes a single display. In another example, the electronic device includes a display for each eye of the user. In some implementations, the one or more displays 612 are capable of presenting XR (extended reality) and VR (virtual reality) content.

In some implementations, the one or more image sensors 614 are configured to obtain image data that corresponds to at least a portion of the face of the user that includes the eyes of the user (any may be referred to as an eye-tracking camera). In some implementations, the one or more image sensors 614 are configured to be forward-facing so as to obtain image data that corresponds to the physical environment as would be viewed by the user if the electronic device 600 was not present (and may be referred to as a scene camera). The one or more optional image sensors 614 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an environment presentation module 640.

The operating system 630 includes procedures for handling various basic system services and for performing hardware dependent tasks. In some implementations, the scene composing module 640 is configured to present an scene composing user interface to the user via the one or more displays 612. To that end, in various implementations, the scene composing module 640 includes a data obtaining unit 642, an object rendering unit 644, an object resizing unit 646, and a data transmitting unit 648.

In some implementations, the data obtaining unit 642 is configured to obtain data (e.g., presentation data, interaction data, sensor data, location data, etc.) from the other components of the electronic device 600 and/or a different electronic device. To that end, in various implementations, the data obtaining unit 642 includes instructions and/or logic therefor, and heuristics and metadata therefor.

In some implementations, the object rendering unit 644 is configured to display graphical representations of objects in the scene composing user interface. To that end, in various implementations, the object rendering unit 644 includes instructions and/or logic therefor, and heuristics and metadata therefor.

In some implementations, the object resizing unit 646 is configured to, in response to user input to resize an object, resize the object while resizing child objects of the object according to a construction plan. To that end, in various implementations, the object resizing unit 646 includes instructions and/or logic therefor, and heuristics and metadata therefor.

In some implementations, the data transmitting unit 648 is configured to transmit data (e.g., presentation data, location data, etc.) to other components of the electronic device 600 and/or a different electronic device. To that end, in various implementations, the data transmitting unit 648 includes instructions and/or logic therefor, and heuristics and metadata therefor.

Although the data obtaining unit 642, the object rendering unit 644, the object resizing unit 646, and the data transmitting unit 648 are shown as residing on a single device (e.g., the electronic device 600), it should be understood that in other implementations, any combination of the data obtaining unit 642, the object rendering unit 644, the object resizing unit 646, and the data transmitting unit 648 may be located in separate computing devices.

Moreover, FIG. 6 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having one or more processors and non-transitory memory:
displaying a graphical representation of an object, wherein the object has at least a first child object;
receiving user input to change a size of the object in a dimension of a three-dimensional coordinate system of the object by a percentage; and
in response to receiving the user input:
changing the size of the object in the dimension by the percentage; and
maintaining a size of the first child object in the dimension.

2. The method of claim 1, wherein the object has a second child object, further comprising, in response to receiving the user input, changing a size of the second child object in the dimension by the percentage.

3. The method of claim 1, wherein the object has a second child object, further comprising, in response to receiving the user input, changing a size of the second child object in the dimension by more than the percentage.

4. The method of claim 1, wherein the object has a second child object, further comprising, in response to receiving the user input, changing a size of the second child object in the dimension by less than the percentage.

5. The method of claim 1, wherein the object has a second child object, further comprising, in response to receiving the user input, changing a size of the second child object in a direction opposite the change in size of the object.

6. The method of claim 1, wherein the object has a second child object, further comprising, in response to receiving the user input, removing the second child object.

7. The method of claim 6, wherein removing the second child object includes replacing the second child object with a third child object.

8. The method of claim 1, further comprising, in response to receiving the user input, adding a second child object to the object.

9. The method of claim 1, further comprising, in response to receiving the user input, maintaining a position of the first child object in the dimension.

10. The method of claim 1, further comprising, in response to receiving the user input, changing a position of the first child object by more than the percentage.

11. The method of claim 1, further comprising:
receiving second user input to change a size of the object in a second dimension of the three-dimensional coordinate system of the object by a second percentage; and
in response to receiving the second user input:
changing the size of the object in the second dimension by the second percentage; and
changing a size of the first child object in the second dimension by at least the second percentage.

12. The method of claim 1, further comprising, storing a construction plan of the object, wherein maintaining the size of the first child object in the dimension is performed according to the construction plan.

13. The method of claim 12, wherein the object has a second child object, further comprising changing a size of the second child object in the dimension according to the construction plan.

14. The method of claim 13, wherein the construction plan specifies the size of the second child object in the dimension for various sizes of the object in the dimension.

15. The method of claim 14, wherein the construction plan further specifies a position of the second child object in the dimension for the various sizes of the object in the dimension.

16. A device comprising:
a non-transitory memory; and
one or more processors to:
display a graphical representation of an object, wherein the object has at least a first child object;
receive user input to change a size of the object in a dimension of a three-dimensional coordinate system of the object by a percentage; and
in response to receiving the user input:
change the size of the object in the dimension by the percentage; and
maintain a size of the first child object in the dimension.

17. The device of claim 16, wherein the one or more processors are further to store a construction plan of the object and maintain the size of the first child object in the dimension according to the construction plan.

18. The device of claim 17, wherein the object has a second child object and the one or more processors are further to change a size of the second child object in the dimension according to the construction plan.

19. The device of claim 18, wherein the construction plan specifies the size of the second child object in the dimension for various sizes of the object in the dimension.

20. A non-transitory memory storing one or more programs, which, when executed by one or more processors of a device, cause the device to:
display a graphical representation of an object, wherein the object has at least a first child object;
receive user input to change a size of the object in a dimension of a three-dimensional coordinate system of the object by a percentage; and
in response to receiving the user input:
change the size of the object in the dimension by the percentage; and
maintain a size of the first child object in the dimension.
